(19) United States
(12) Patent Application Publication
(10) Pub. No.: US 2005/0076089 A1
(43) Pub. Date: Apr. 7, 2005

(54) Method and system for communication from anonymous sender(s) to known recipient(s) for feedback applications

(76) Inventor: Arnoldo Medeiros Fonseca, Levittown, PA (US)

Correspondence Address: Mr. Arnoldo Fonseca, 31 Daffodil Lane, Levittown, PA, 19055, US

(21) Appl. No.: 10/941,484

(22) Filed: Sep. 15, 2004

Related U.S. Application Data
(60) Provisional application No. 60/504,027, filed on Sep. 18, 2003.

(51) Int. Cl. G06F 15/16

(52) U.S. Cl. 709/206

(57) ABSTRACT

The invention describes a method and system for communication from one or more anonymous sender(s) and to one or more known recipient(s). This method involves the use of a trusted third party that: receives messages from a sender(s), validates the sender(s) and message destination, removes identifying header information from the message, stores the message for a random time period, and then sends to a defined set of recipient(s), all messages received, in random order. The third party receives messages in various formats and sends messages in recipients' preferred format. By holding messages for a random period of time and then sending them in random order to recipients, the third party diminishes the effectiveness of traffic monitoring activities. This invention is particularly designed for applications where senders are providing qualitative feedback to recipients, including but, not limited to, employee-employer communications, collaborative brainstorming, employee knowledge capture and dissemination, and customer-to-vendor feedback.

### CROSS-REFERENCE TO RELATED APPLICATIONS

Pursuant to 35 U.S.C. § 119(e)(1), this application claims priority of Provisional Patent Application No. 60/504,027 filed on Sep. 18, 2003.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention relates generally to information communication and information processing systems and, more particularly, to methods for communication of messages from one or more anonymous sender(s) to one or more known recipient(s).

2. Prior Art

There are a number of everyday situations that benefit from the ability of a person or group to send a message anonymously to another person or group. Government tip-hotlines for instance solicit information from the public to help solve or forestall crime but often do not require callers to identify themselves. Crisis counseling hotlines similarly enable callers to discuss concerns without fear of being identified. At heart to the efficacy of these situations is the fact that sender anonymity can enhance the quality and truthfulness of communication. By ensuring sender privacy and confidentiality, anonymity reduces perceived risk and cost by the sender to providing the communication. In some situations, sender anonymity can also enable recipients to make more objective judgments, such as when a school teacher needs to objectively evaluate eyewitness accounts of school-yard malfeasance from persons whose identities would otherwise bias his or her judgment. Note that in this application, those providing feedback messages are referred to as senders, while those receiving feedback are recipients.

In the arena of human feedback regarding employment, consumer products, and other topics, anonymity is critical. Feedback such as from employees about an employer, team members about a brainstorming topic, or customers about a product can place those providing the feedback in awkward or sensitive positions should their identity not be safeguarded. Anonymity in the context of feedback applications includes two components: (a) a sender's identity being shielded from a recipient and (b) the recipient not being able to trace the message sending process in a manner that reliably identifies the sender. Unless otherwise specified, the term “anonymity” is used throughout this application to denote both aspects. Examples of the later could occur when recipients video tape senders as they place feedback forms into a suggestion box, possibly enabling a matching of a form to a sender, or when recipients monitor communication network traffic from a sender's computer terminal in order to match access to a particular website with the order in which feedback messages are received. Such practices are referred to as traffic monitoring in this application.

Equally important as anonymity are other characteristics of the feedback sender, feedback process, and feedback recipient that mitigate the efficacy and real-world usability of a feedback application. These key characteristics can be summarized as (a) limited sender access to transmission tools, (b) limited sender sophistication, (c) the ephemeral nature of feedback insight, (d) the voluntary nature of feedback, and (e) the need for sender validation. The first two characteristics describe the feedback sender(s). In some circumstances, would-be senders do not have access to tools (such as a computer or Internet access) prescribed by several prior art. Many would-be feedback senders also do not have the sophistication for undertaking steps required by some prior art (such as using a public-private key to encrypt messages). The next two characteristics involve the feedback process. Feedback comments tend to be ephemeral in the sense that they spark in would-be senders' minds and may dissipate from memory if not readily captured. Feedback also tends to be a voluntary activity and consequently requires systems that are easy to use and pose low opportunity-costs (such as time) on the part of would-be senders. The fifth characteristic describes the recipient(s). For a recipient to value comments received, he or she has to be reasonably confident that messages are being received from authorized senders. A manager, for instance, may need to be assured that the feedback he or she is receiving only comes from his or her employees and not his or her superiors. This need has to be balanced by the anonymity needs of senders. Please note that for ease of illustration, reference to a one sender to one recipient feedback situation will be used below, but those trained in the art will appreciate that the invention disclosed in this application could be used by a diverse set of senders and recipients in various roles and contexts.

Several prior art disclose methods and systems that either involve human feedback or could be applicable to feedback communication. However, past approaches have been limited in fully addressing all the characteristics discussed above. In not meeting these characteristics, past approaches have suffered from four key failings: (a) not providing a flexible means for feedback by senders, (b) not being easy or straightforward to use, (c) not authenticating senders, and (d) not adequately protecting anonymity. Flexibility addresses senders' limited access to tools and the ephemeral nature of feedback by providing multi-faceted means for capturing and then sending feedback messages. Ease of use addresses senders' limited sophistication and the voluntary nature of feedback by lowering would-be senders' opportunity costs (such as time) to sending a feedback message. Authentication and anonymity are direct successors to characteristics discussed above.

Applicable prior art can be categorized into inventions focusing on (a) customer and student feedback, (b) employee information collection, and (c) anonymous communications.

Customer and Student Feedback

In the area of feedback acquisition from customers, U.S. Pat. No. 4,345,315 to Cadotte and Hester (1982) discloses a physical computer terminal whereby retail customers can key in their feedback for electronic processing. The use of the device, however, limits anonymity as the user is in plain view of others near the vicinity of the machine, and it can be inconvenient for users since its access is limited by geography. The scope of the invention is also limited to a defined set of recipients (the retail store that owns the terminal).

U.S. Pat. No. 5,668,953 to Sloo (1997) discloses a method and system for handling individual complaints, possibly in an anonymous fashion. This invention is an example feedback processing application that is intended for a specifically defined type of feedback (complaints). The invention is intended for communication between a consumer and a vendor where the message involves a complaint requiring response by the vendor. As a result of handling complaints, the invention requires a two way communication channel so that the vendor can reply to the consumer complaint. The invention also requires users to have access to computer networks and to an electronic mail address. This invention also does not directly authenticate senders; a malicious sender could fabricate complaints without ever having purchased a vendor's product. Efforts to ensure anonymity from traffic monitoring are also minimal. The applicability of the invention to contexts other than that of its design is consequently limited. For instance, its construction is not purposed on enabling a sender to send feedback to multiple recipients simultaneously.

U.S. Pat. No. 6,510,427 to Bossemeyer and Connolly (2003) describes a system for the capture and analysis of customer feedback that addresses most of the failings of other systems. Nevertheless, the aim of the invention is to aggregate feedback data collected in order to perform data mining and other analytic functions. This necessitates that feedback data be intermediated by service representatives in order to capture the data and to structure the data in a manner usable by the system for subsequent analysis. As a result of its intent, the invention is limited to one recipient (the database aggregating collected data) and it potentially compromises anonymity due to service representative intermediation. U.S. Pat. No. 5,822,744 to Kesel (1998) also describes a customer feedback acquisition tool purposed on data aggregation and analysis, and it contains similar shortcomings as discussed above. U.S. patent application 20040176995 to Fusz (2004) also discloses a survey-style system for collecting anonymous consumer responses to marketing-related questions. This invention requires users to maintain a profile in order to participate provide such feedback, making it much less useful for application contemplated in this application. It also possesses similar shortcomings discussed above.

U.S. patent application 20020116462 to DiGiano, Roschelle, and Vahey (2002) discloses a method for handling feedback generated by persons within a group setting. This invention is purposed on enabling real-time feedback within the classroom in order to enhance the learning process. It can be used for anonymous feedback in cases where senders' feedback messages are stripped of sender identification. As with U.S. Pat. No. 5,668,953 above, this invention is successful within its targeted feedback-domain (in this case, classroom-style interaction), but it fails to meet the requirements for other feedback applications. The invention is suitable primarily for situations where senders are interacting with recipients in an insular context. As a real-time tool, this invention is also limited in its ability to stop traffic monitoring efforts. It is also limited to electronic devices able to quickly provide the real-time feedback collection and data display services provided by the invention. Other media such as paper or facsimile are impractical for the uses contemplated. This invention is also limited by construction to cases where a plurality of senders send messages to the group leader and/or to themselves.

Employee Information Collection

Several inventions have been created in the employee management arena, but most aim at managing employee information for use by employers rather than enabling anonymous employee feedback to employers. U.S. Pat. No. 6,049,776 to Donnelly, Robinson, and Reese (2000) describes a human resource management system that is focused on managing employee profile information and scheduling employee activities and tasks; however no functionality is specifically designed for anonymous employee feedback. U.S. Pat. No. 6,385,620 to Kurzius and Johnston (2002) discloses a similar system that aims to capture personal profile information for recruiting purposes; it does not focus on providing users with anonymous feedback capability.

U.S. Pat. No. 6,556,974 to D'Alessandro (2003) discloses a system that collects employee survey responses to generate organizational performance data. Although the system does indirectly enable employee feedback, such feedback is structured and biased by the questions outlined by the survey. Since the aim of the data collection is organizational performance measurement, many employee feedback comments are not captured by the system. Furthermore, the invention makes no distinct provision for employee anonymity and only has one possible recipient (a database storing survey responses). U.S. Pat. No. 5,551,880 to Bonnstetter and Hall (1996) is similar to the above by disclosing a system for predicting the potential success of an individual for a particular job or task based on survey data collection. This invention poses the same shortcomings as the above.

Anonymous Communications

Several methods and systems enabling anonymous communication between parties have been disclosed which could be fashioned to permit anonymous feedback. For instance, U.S. Pat. No. 5,907,677 to Glenn, et al. (1999) discloses a method enabling anonymous communication between two parties by assigning each party a code used as a pseudonym for inter-party communication. This invention could be utilized for feedback applications if the true identify of the recipient were revealed to would-be senders. In this case, for recipients to then also act as senders (such as when they wish to send feedback to their managers), they will have to maintain two user accounts, one where their identity is exposed and one where their identity is hidden, a cumbersome solution. Because users of the system are identified by a pseudonym, in some situations it could also be possible to estimate identities through an analysis of which pseudonyms are part of what communication flows. Furthermore, no manner of checking that a message received by a recipient comes from an authorized sender is built into the invention. In addition, the invention has to store sender information in order to assign a sender the pseudonym code, diminishing the perceived anonymity by the sender. No anti-traffic monitoring initiatives are provided. U.S. patent application 20030061484 to Noble (2003) discloses a similar method whereby a trusted third party assigns a code to users. This code is then used as a means for user authentication and anonymous communication with other users. Due to its use of digital certificates and virtual meeting rooms, this invention is only reliably implemented through electronic media, limiting accessibility to some would-be senders. This invention also poses similar challenges as U.S. Pat. No. 5,907,677 above.

U.S. Pat. No. 5,913,212 to Sutcliffe and Dunne (1999) discloses a system enabling anonymous electronic communication between two parties. This invention is crafted for personals applications (e.g. the invention is an electronic analog to newspaper personal advertisements), and consequently its usability for feedback applications is limited. As with U.S. Pat. No. 5,907,677 above, recipients would need to identify themselves in order for senders to communicate with them. This invention also requires users to utilize computer networks like the Internet to obtain access, limiting accessibility to some would-be senders. The system also collects personal profile information, which some would-be senders may be reluctant to furnish. Lastly, no authentication scheme for matching senders to recipients is provided. U.S. Pat. No. 5,884,272 to Walker, Schneier, and Case (1999) provides for an invention that also enables anonymous communications between parties whereby personal information is used to match parties based upon criteria without initially revealing their identity. In this invention, the parties are given means to progressively reveal identifying information to each other. This invention poses the same failings in respect to feedback applications as U.S. Pat. No. 5,913,212 above. U.S. Pat. No. 6,665,389 to Haste (2003) discloses a system to empower anonymous matching within the context of a dating service. In addition so some of the setback of the above with respect to its applicability for anonymous feedback applications as contemplated, this invention requires both parties to disclose personal information in order to utilize the system, which would be unpractical in promoting trust of anonymity by users. U.S. patent application 20030084103 to Weiner and Stilmann-Hirsch (2003) provides an invention with similar function as the above. This invention however extends the breadth of communication modes that may be used to include several means that do not require the Internet (such as use of a telephone-based interactive voice response system). Nonetheless, this invention also relies on personal information collection in order to enable matching among users. It also assigns or uses pseudonyms for user-identification. Both of these characteristics pose the same problems as discussed above. Additionally, no anti-traffic monitoring method are provided.

U.S. Pat. No. 6,209,100 to Robertson, O'Shea, and Fortenberry (2001) discloses a method for enabling anonymous posting of messages to a moderated forum. The essence of the invention involves forum administrators removing identifying information from inbound messages and then posting those messages deemed appropriate into a forum. While this invention could be utilized for feedback applications, it does not establish clear sender-to-recipient authentication and potentially enables anyone with access to the forum to view posted messages. Furthermore, it entails third-party (the forum administrators) qualitative review of messages, which may censure valid messages. By construction, this invention also requires access to the World Wide Web.

U.S. Pat. No. 6,021,200 to Fischer (2000) discloses a system for counting of data from anonymous senders, providing a means for electronic voting for instance. It accomplishes this by decoupling the authentication of messages received from the processing, or counting, of the content contained within the message. While this approach could be extended for feedback applications, as construed, it is limited to survey-style data aggregation rather than serving as a sender-to-recipient communication platform. The approach also only has one implied recipient and requires the use of the electronic medium for its usage. U.S. Pat. No. 5,682,430 to Kilian and Sako (1997) discloses an invention with similar scope as the patent above but using a different algorithm for anonymity. In this case, the use of several mixing centers removes sender identity and can defeat traffic monitoring activities by recipients. Nonetheless, this invention poses the same shortcomings as those in U.S. Pat. No. 6,021,200 above.

U.S. Pat. No. 5,812,670 to Micali (1998) describes a method for anonymous communication between two parties. This method can be utilized for anonymous feedback applications and does address many of the shortcomings of other applications. Nonetheless, it involves sophisticated tools such as encryption keys which are not accessible to some would-be feedback senders and which limit its usability to electronic media for sending messages. Consequently, the invention is not well-suited for handling relatively low-value feedback comments generated in the course of the average person's role as an employee, as it poses potentially high time-costs for its use. An expressed scheme for validating that recipient messages come from authorized senders is also not included. U.S. patent application 20020004900 to Patel (2002) discloses an analogous method for anonymous communication through the use of anonymous certificates. In this invention, user identity is shielded, but a third party certificate authority asserts characteristics about the sender to a recipient. Nonetheless, for everyday, relatively low-value feedback comments, this invention poses the same challenges as U.S. Pat. No. 5,812,670 above. It utilizes sophisticated digital certificates and requires the use of electronic communication, imposing high costs and inherent limitations onto would-be senders.

U.S. Pat. No. 6,591,291 to Gabber et al. (2003) discloses a method for anonymous communication through the remailing of electronic mail messages. The recipient is not able to identify the sender because a remailer has substituted an aliased electronic mail address for the sender's. This invention could be used for anonymous feedback applications, but it poses several potential problems. First of all, the recipient has little control over who sends him or her electronic mail messages, which can lead to abuse. Second, no provisions are made against traffic monitoring by recipients. Third, owing to the nature in which the invention uses the destination address to compute an alias, it may not be possible for the sender to send one message to multiple recipients. Lastly, not all would-be feedback senders have access to electronic mail.

U.S. patent application 20040111612 to Choi et al. (2004) describes an invention whereby a central system intermediates between group communications in such a manner as to enable message recipients to reply to a sender without the need to know the sender's identity. This invention is complementary to that contemplated in this application by potentially extending its reply-to-sender capabilities in limited contexts; nevertheless, its particular emphasis make it distinct in capability and scope. Its focus on enabling reply capability limits the invention by requiring a sender to disclose identifying information, whereas the present invention does not necessitate identifying information to effectuate a message transmission (such when performed through an Internet form, facsimile, or paper transmission). Being groupware-focused, the invention's mechanism implies the need for senders to be part of a system-defined group or at least to be defined within the messaging system in order to enable access control and to assure anonymous messaging; through the use of a passkey for authentication (rather than group-owner access control), the contemplated system does not pose this requirement. The invention's process of converting a group message to multiple one-to-one messages is based on its need to keep anonymity among group members and to enable its reply functionality; this application describes a system that is not bound by this conversion process since its purpose assumes that the set of recipients is known among the recipients themselves and known to the sender. Beyond its limited channels for message delivery, the invention is also limited in its message transmission channels, limiting its usefulness in context otherwise enjoyed by the contemplated invention.

U.S. patent application 20020027901 to Liu and Chang (2002) discloses a method for anonymous voice communication. A third party is utilized to enable senders to anonymously talk with recipients. Part of the efficacy of the anonymity provided by the invention lies in the fact that the sender and recipient do not necessary know each other prior to communication. For situations where a sender and recipient do know each other, anonymity can be compromised because the recipient may recognize the voice of the sender. This invention does not directly provide for means to shield or disguise the voice of the communicating parties; it hides the address information of their voice terminals (e.g. telephone number). Furthermore this invention is limited as to its transmission modes. By virtue of using real-time, peer-to-peer voice communication, safety from recipient traffic monitoring is not safeguarded.

### BRIEF SUMMARY OF THE INVENTION

Summary

The invention describes a method and system for communication from one or more anonymous sender(s) and to one or more known recipient(s). This method involves the use of a trusted third party that: receives messages from one or more senders, validates the sender and destination of the message, removes identifying header information from the sender's message, stores the message for a short, random period of time, and sends to a defined set of one or more recipients, all messages, in random order, that have been received during the said short period of time. The trusted third party receives messages from senders in various formats and sends messages to recipients in their preferred format. By holding messages for a short, random period of time as well as, when possible, sending to recipients communications that contain several sender messages listed in random order, the trusted third party diminishes the effectiveness of traffic monitoring activities by the recipients. The method described by this invention is particularly designed for applications where senders are providing qualitative feedback information to recipients, including but, not limited to, employee-employer communications, collaborative brainstorming, employee knowledge capture and dissemination, and customer-to-vendor feedback.

Objects and Advantages

From the discussion above, several objects and advantages of the invention include:
(a) Senders have various means through which to transmit feedback messages to recipients. The invention can interface with any input source that is able to convert messages to electronic text. The preferred embodiment presented includes feedback submission through electronic mail, text messaging, the World Wide Web, facsimile, instant messaging, paper, and voice through an interactive voice response system;
(b) The range of message submission options allows users to provide feedback without elevated levels of sophistication and without access to sophisticated tools;
(c) The various message submission options also enable senders to more readily capture feedback insights;
(d) The choice of message submission options poses low opportunity costs for senders, since at least one option is likely to be familiar and easily accessible to senders;
(e) Sender identity is safeguarded through intermediation by the invention;
(f) The invention utilizes an algorithm to obfuscate traffic monitoring efforts by recipients;
(g) The invention ensures that messages recipients receive are sent by senders with valid authorization, thereby providing recipients with some assurance as to the audience providing the feedback; and
(h) The invention enables various feedback communication flows, including: one sender to one recipient, one sender to many recipients, many-senders to one recipient, and many senders to many recipients.

Other objects and advantages include the ability of recipients to receive messages in a preferred media and format, from a choice of many options. The preferred embodiment details electronic mail, facsimile, physical hardcopy, and voice through telephone as options. Those experienced in the art may appreciate that other forms of feedback submission by senders and receival by recipients could be used with the invention. A further object and advantage is the ability of senders to categorize their feedback comments, enabling recipients to later browse through feedback organized by these categories. Such capability may be useful for team work oriented situations where feedback may need to be obtained about and organized by various specific issues. Still further objects and advantages of the invention will become apparent from consideration of the drawings and ensuing description.

### BRIEF DESCRIPTION OF THE SEVERAL VIEWS OF THE DRAWINGS

A more complete understanding of the present invention may be obtained from consideration of the following description in conjunction with the drawings, in which:

FIG. 1 is a high-level overview of the basic method and process governing the invention.

FIG. 2 is a high-level overview of the basic method and process governing the invention with additional input and output components that more fully depict the preferred embodiment of the invention.

FIG. 3A is a process flowchart for the Reminder Module, which acts to remind senders to send messages to one or more recipients.

FIG. 3B is a continuation of FIG. 3A.

FIG. 3C is a continuation of FIG. 3A.

FIG. 4.1A is a process flowchart for the Electronic Mail Message Receival Module, which receives inbound electronic mail messages.

FIG. 4.1B is a continuation of FIG. 4.1A.

FIG. 4.2 is a process flowchart for the Text Messaging Message Receival Module, which receives inbound wireless text messaging messages.

FIG. 4.3A is a process flowchart for the Fax Message Receival Module, which receives inbound facsimile messages.

FIG. 4.3B is a continuation of FIG. 4.3A.

FIG. 4.3C is a continuation of FIG. 4.3B.

FIG. 4.4A is a process flowchart for the Paper Message Receival Module, which receives inbound paper messages.

FIG. 4.4B is a continuation of FIG. 4.4A.

FIG. 4.4C is a continuation of FIG. 4.4A.

FIG. 4.5A is a process flowchart for the Interactive Voice Response Message Receival Module, which receives inbound interactive voice response-processed messages.

FIG. 4.5B is a continuation of FIG. 4.5A.

FIG. 4.5C is a continuation of FIG. 4.5B.

FIG. 4.6 is a process flowchart for the Web-based Form Message Receival Module, which receives inbound messages from a World Wide Web website.

FIG. 4.7 is a process flowchart for the Instant Messaging Message Receival Module, which receives inbound instant messaging messages.

FIG. 5A is a process flowchart for the Message Preprocessing Module, which formats and standardizes data received by the invention.

FIG. 5B is a continuation of FIG. 5A.

FIG. 6A is a process flowchart for the Message Authentication Module, which validates a sender(s) and intended recipient(s) of a message received.

FIG. 6B is a continuation of FIG. 6A.

FIG. 6C is a continuation of FIG. 6A.

FIG. 7A is a process flowchart for the Message Aggregation Module, which stores authenticated messages received by the invention for later transmission to intended recipient(s).

FIG. 7B is a continuation of FIG. 7A.

FIG. 8 is a process flowchart for the Message Sender Scheduler Module, which periodically initiates the process of outbound message transmission to recipients once certain conditions have been met.

FIG. 9A is a process flowchart for the Outgoing Message Preparer Module, which generates a message that will be transmitted to recipient(s).

FIG. 9B is a continuation of FIG. 9A.

FIG. 9C is a continuation of FIG. 9B.

FIG. 10 is a process flowchart for the Message Posting Module, which performs the transmission of outbound messages.

FIG. 11 is a process flowchart for the Web-based Viewer Module, which enables recipient(s) to access messages received by the invention through a World Wide Web website.

FIG. 12.1 is a process flowchart that describes the send function of the Email Message Sender Object, which sends a message as electronic mail to recipient(s).

FIG. 12.2 is a process flowchart that describes the send function of the Fax Message Sender Object, which sends a message as a facsimile to recipient(s).

FIG. 12.3 is a process flowchart that describes both the send function of the Paper Message Sender Object and related manual processing, which enable the invention to send a message as a physical hardcopy document to recipient(s).

FIG. 12.4 is a process flowchart that describes both the send function of the Voice Message Sender Object and related manual processing, which enable the invention to send a voice message to recipient(s).

FIG. 13 is a process flowchart for the Failure Posting Module, which informs senders of failure in their attempt to send a message to recipient(s).

FIG. 14 is an entity-relationship diagram of database tables used by the invention.

FIG. 15A describes database tables used by the invention in greater depth.

FIG. 15B is a continuation of FIG. 15A.

FIG. 15C is a continuation of FIG. 15B.

FIG. 16A describes programming interfaces for the programming objects used by the invention.

FIG. 16B is a continuation of FIG. 16A.

FIG. 16C is a continuation of FIG. 16B.

### DETAILED DESCRIPTION OF THE INVENTION

The present invention is described using the context of one sender, such as an employee, sending an anonymous feedback message to one recipient, such as a manager. However, the present invention is useful in many applications where one or more senders wish to provide anonymous messages to one or more known recipients. Accordingly, the invention is not to be limited to the particular context or embodiments described herein. The term recipient group is used to denote a list, collection, or catalog that contains one or more recipients. Consequently, sending a message to a recipient group implies the transmission of that message to all individual recipients that are part or member of the recipient group.

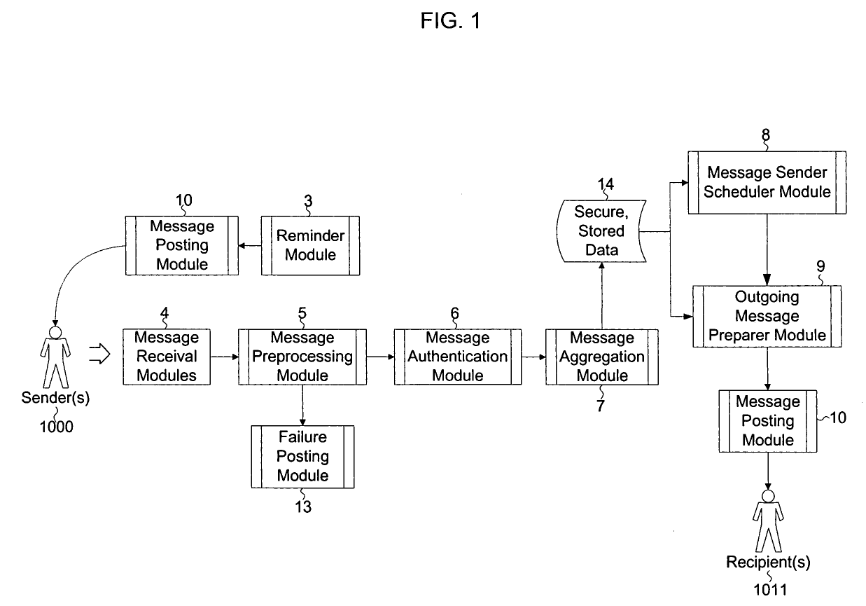

FIG. 1 illustrates the high-level process flow of the invention. The processes performed by the invention are for the most part performed by a computer software program running on a computer system. The computer requires an operating system providing a file system structure capable of creating, storing, and deleting electronic files and directories. Each recipient group served by the invention will have a designated file system directory wherein files may be stored. A database management system is also required that can execute basic Structured Query Language (SQL) commands. Implementing the invention also requires a programming language. As those skilled in the art may appreciate, specific implementation details of the invention may vary slightly based on the programming language, computer operating system, database system, and computer hardware used. Nonetheless, the choice of language, operating system, database, and hardware is independent to the tasks performed by the invention, since the invention can be fashioned to work on most available combinations of configurations. Furthermore, alternative implementations could supplant the use of software by implanting the logic disclosed into hardware. Alternatively, rather than utilizing an operating file system directory for storage, the invention could use other forms of electronic memory such as CD-ROMs or Random Access Memory.

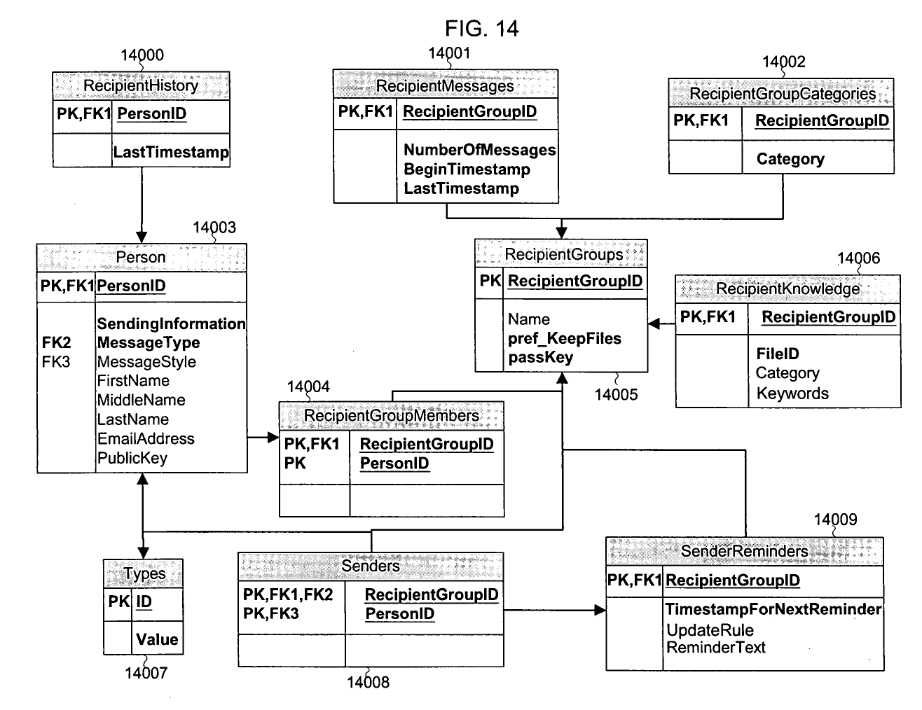

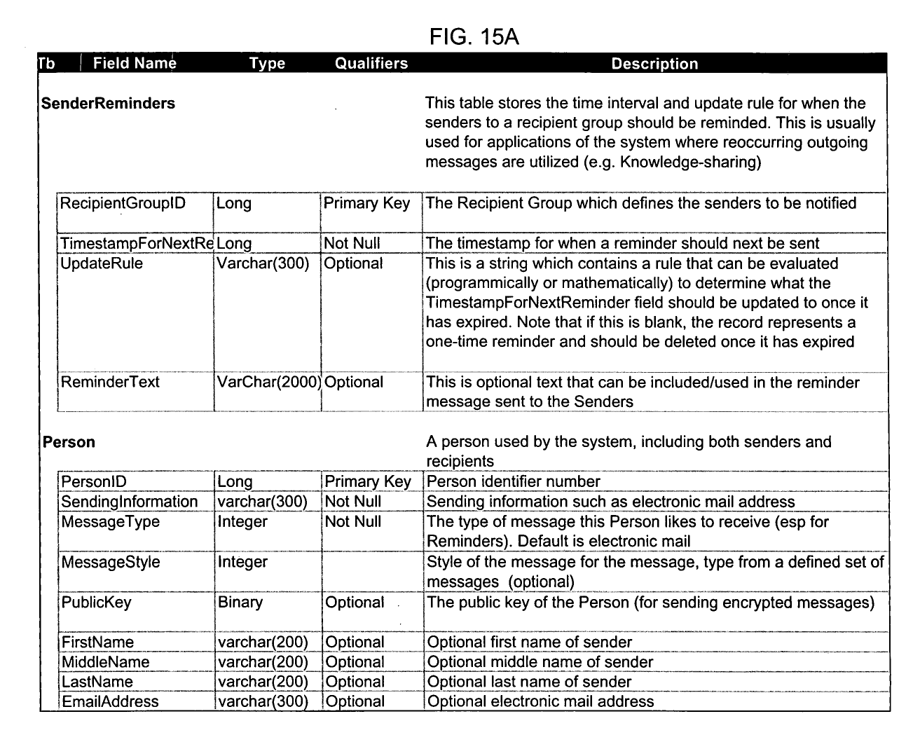

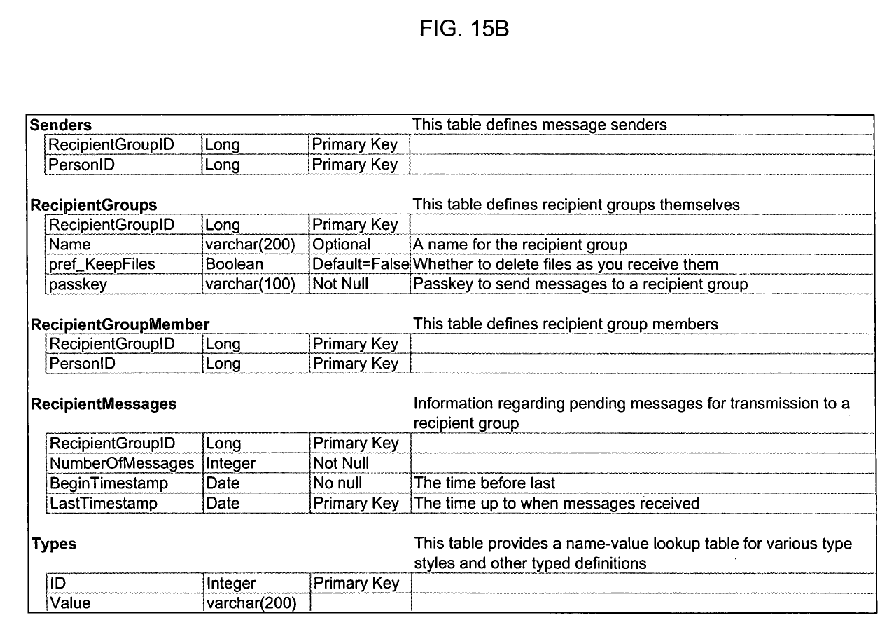

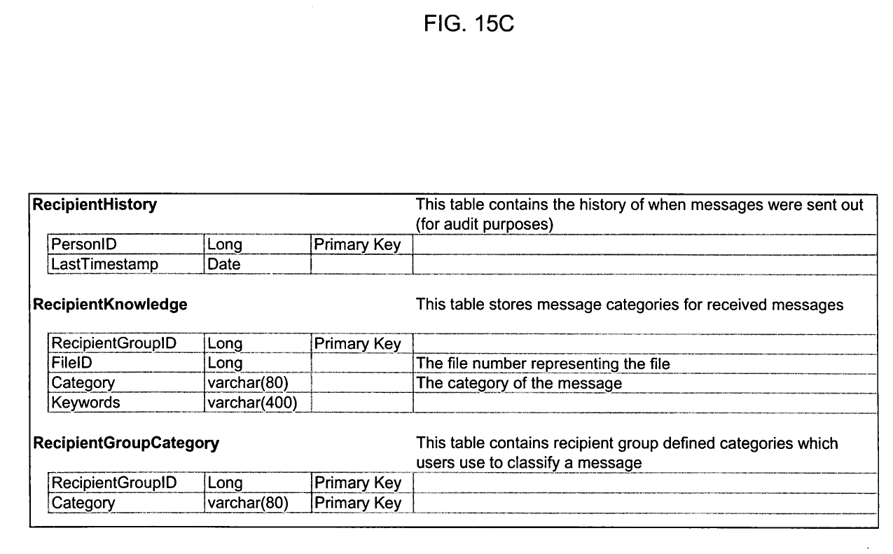

FIGS. 14 and 15A, 15B, and 15C contain a description of a relational database schema used by the invention. FIG. 14 illustrates an Entity-Relationship diagram of the schema, and FIGS. 15A, 15B, and 15C outlines the tables and their respective fields in greater depth. This schema is provided to aid in the explanation of the operation of the invention, and alternative designs for the schema could include more tables or additional fields within tables defined or use of object-oriented schema. Some tables, such as RecipientHistory and RecipientGroupCategories, could be removed without significant impact on the workings of the invention.

Some tasks undertaken by the invention are performed by manual human labor, due to inadequacies of presently available technologies to perform such tasks. However, such tasks could be performed through automated means should future technologies present such capabilities, and the method described by the invention should not prescribe only manual modes of operation to said tasks. In addition, several of the automated tasks performed by the invention could be performed manually, and the invention is not limited to automated modes for such tasks.

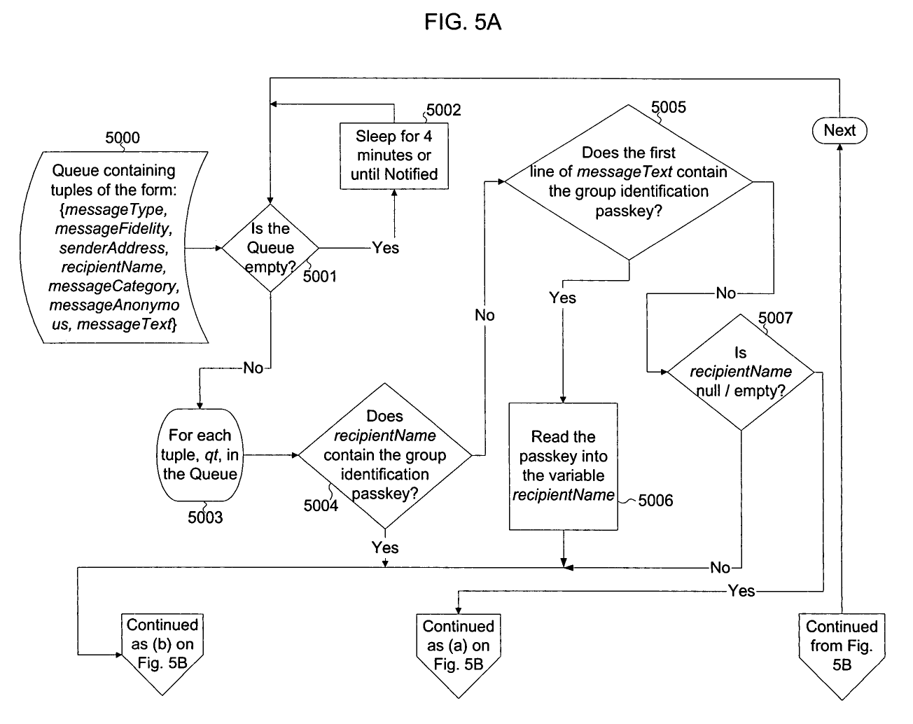

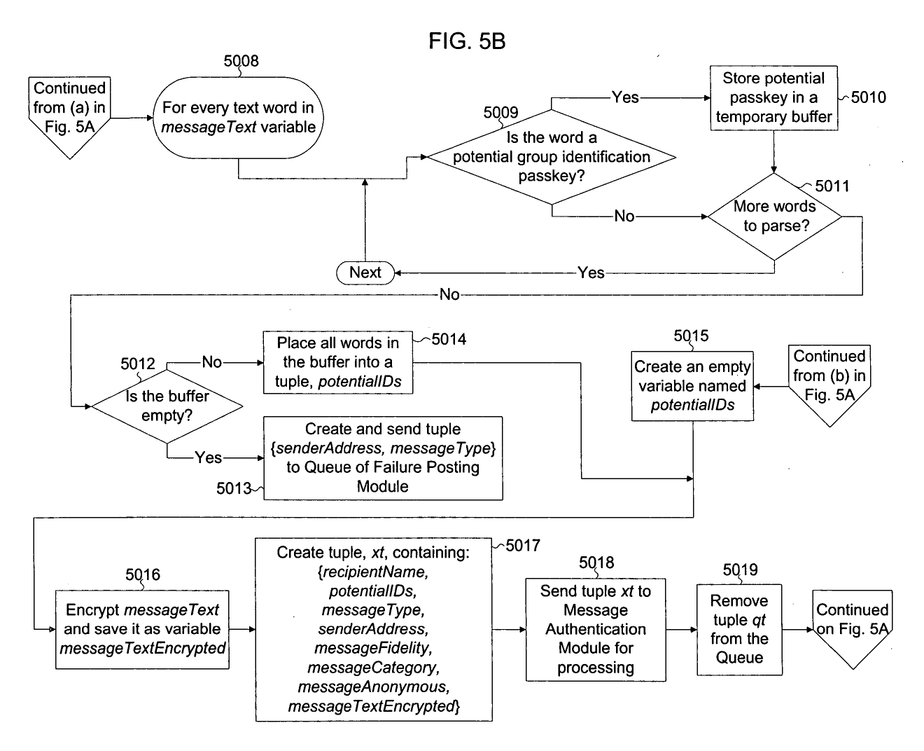

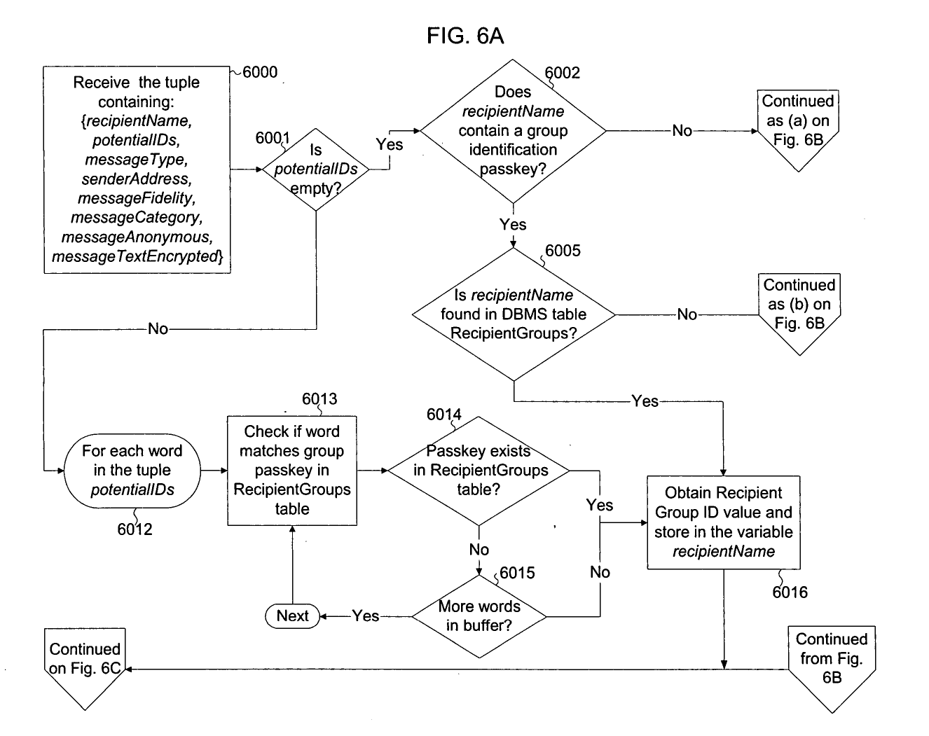

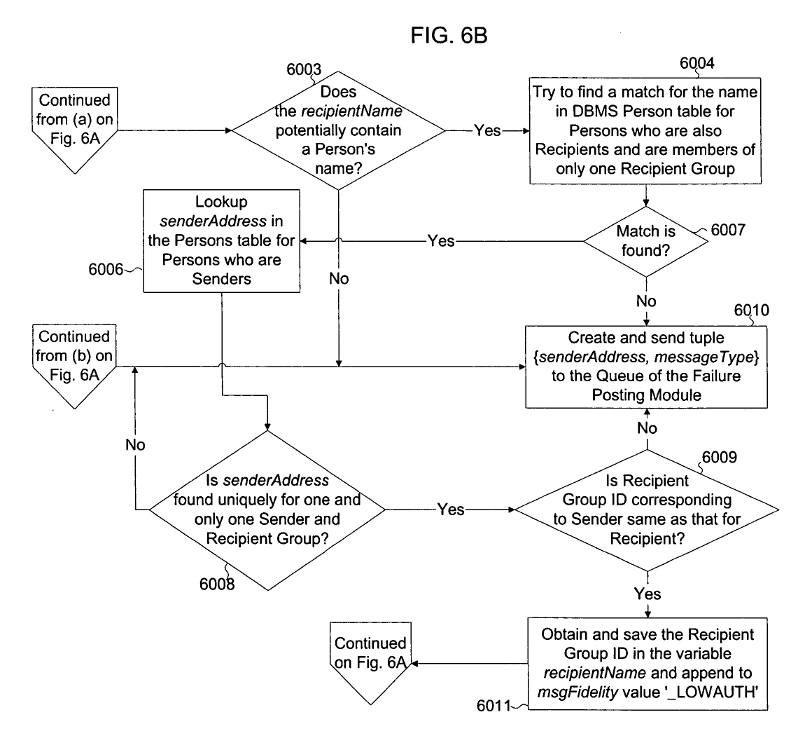

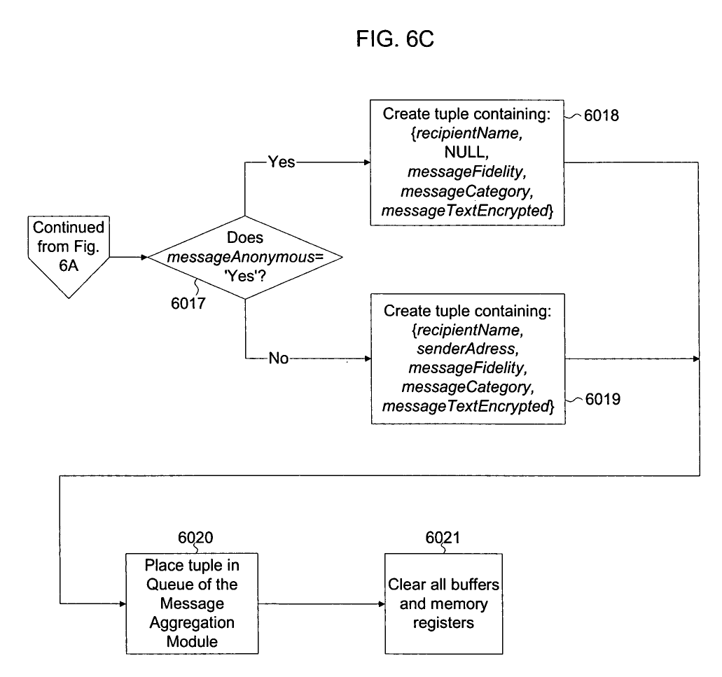

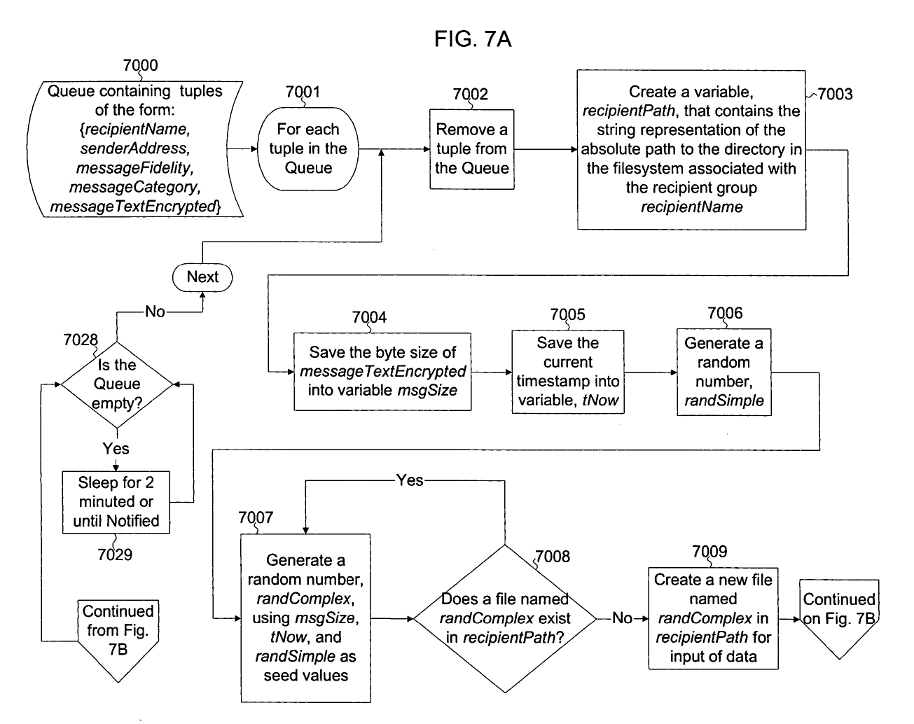

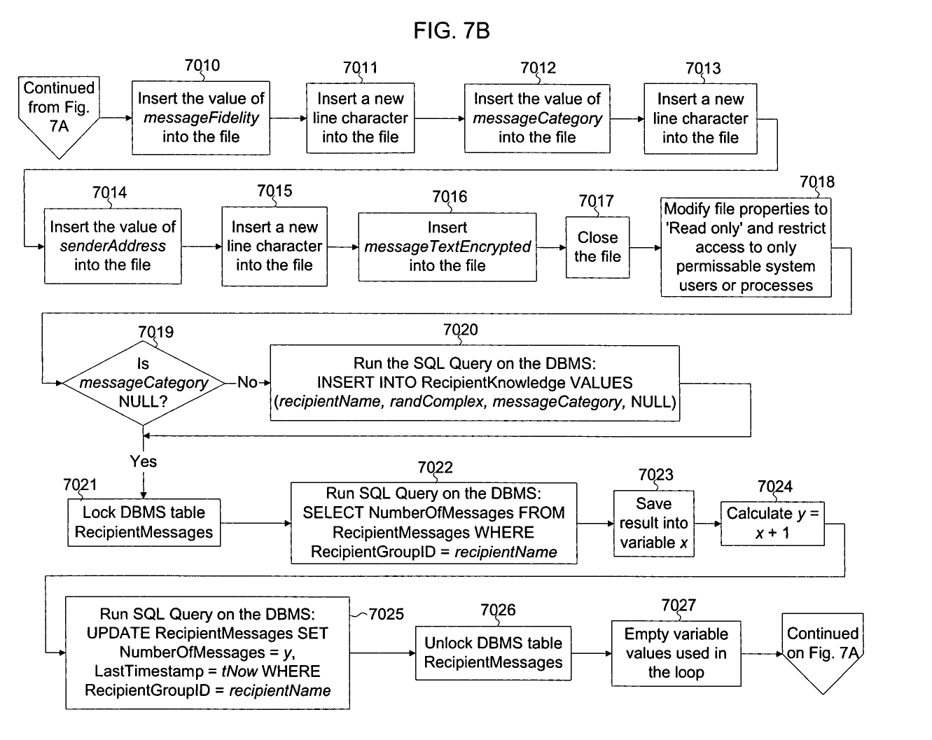

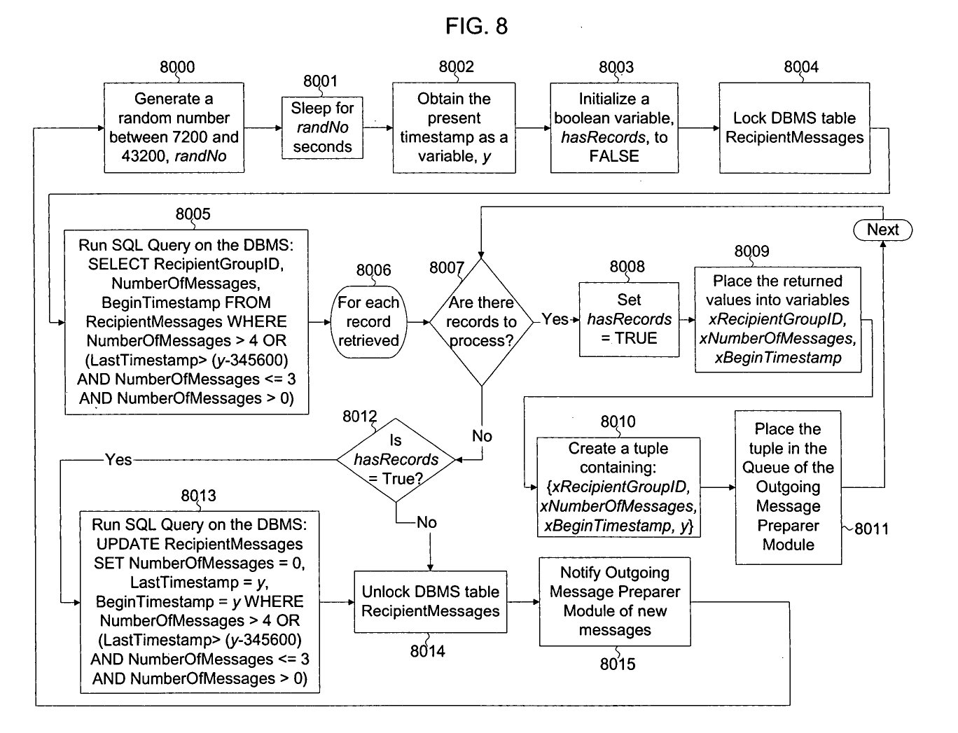

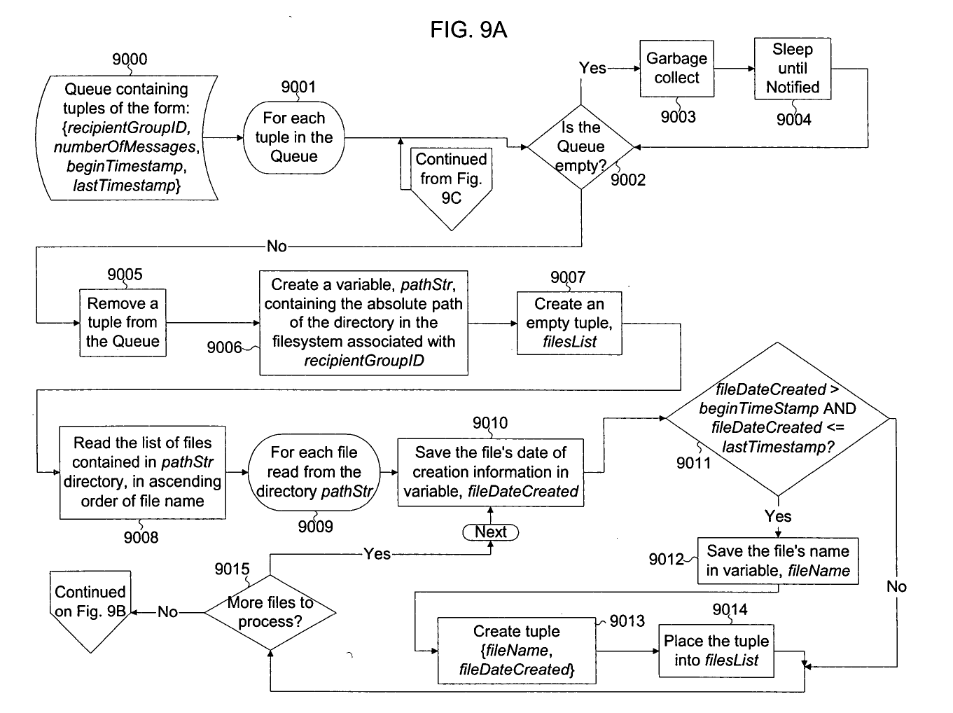

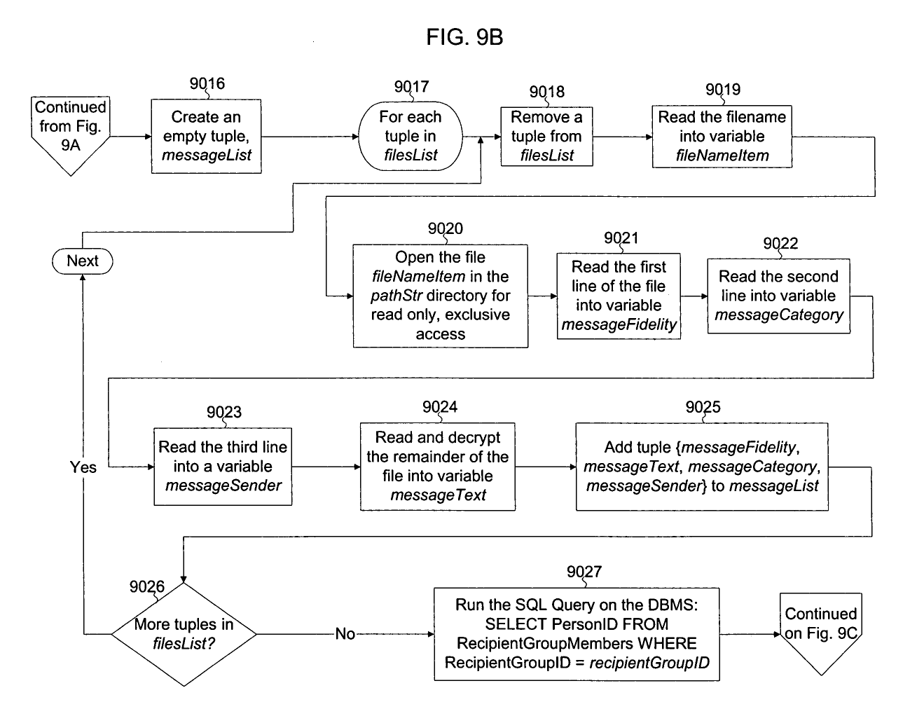

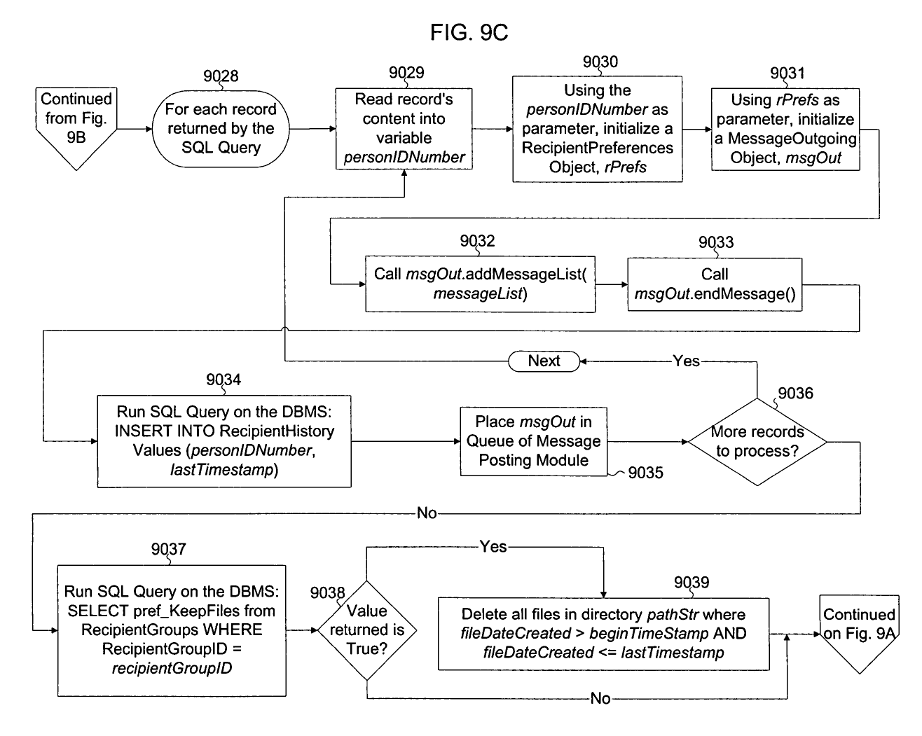

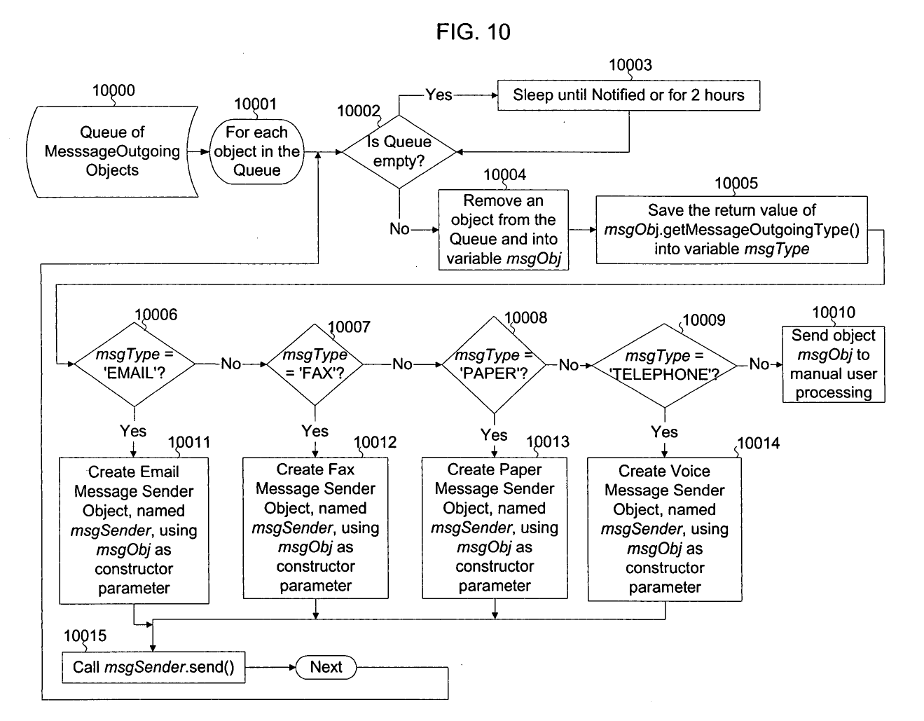

At a high level, the invention consists of a sender 1000 transmitting a message that is received 4 by the invention. The message is processed through six steps, each encapsulated by a unit of organization described as a module:
(a) a Message Preprocessing Module 5 further described in FIGS. 5A and 5B (encompassing 20 steps, 5000 to 5019);
(b) a Message Authentication Module 6 further described in FIGS. 6A, 6B, and 6C (encompassing 22 steps, 6000 to 6021);
(c) a Message Aggregation Module 7 further described in FIGS. 7A and 7B (encompassing 30 steps, 7000 to 7029);
(d) a Message Sender Scheduler Module 8 further described in FIG. 8 (encompassing 16 steps, 8000 to 8015);
(e) an Outgoing Message Preparer Module 9 further described in FIGS. 9A, 9B, and 9C (encompassing 40 steps, 9000 to 9039); and
(f) a Message Posting Module 10 further described in FIG. 10 (encompassing 16 steps, 10000 to 10015).

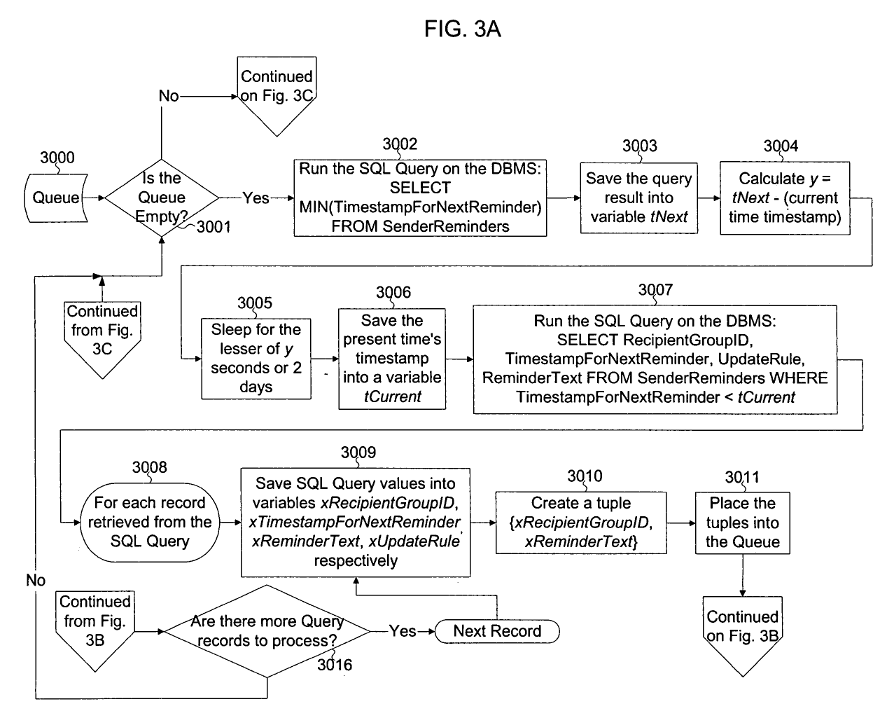

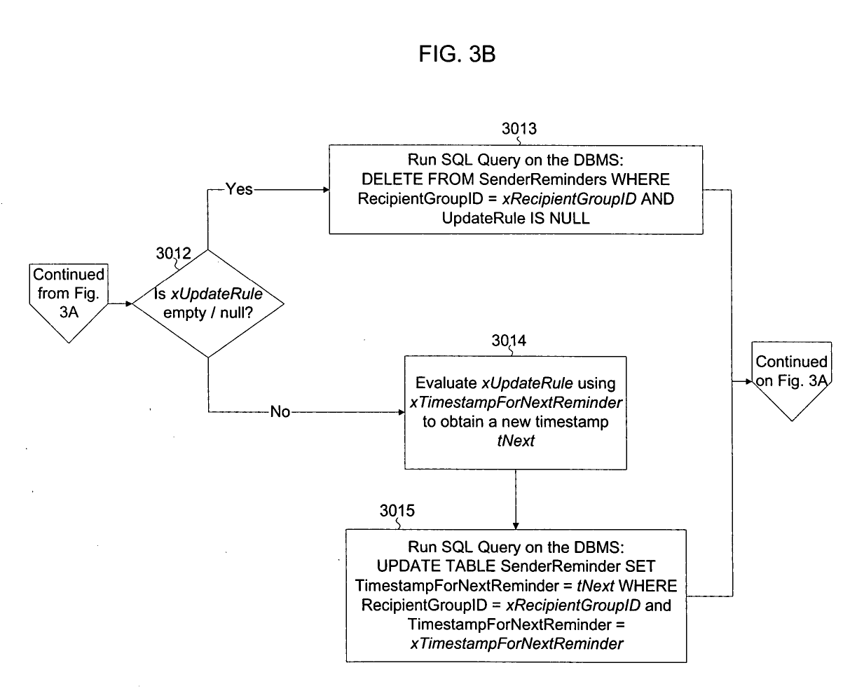

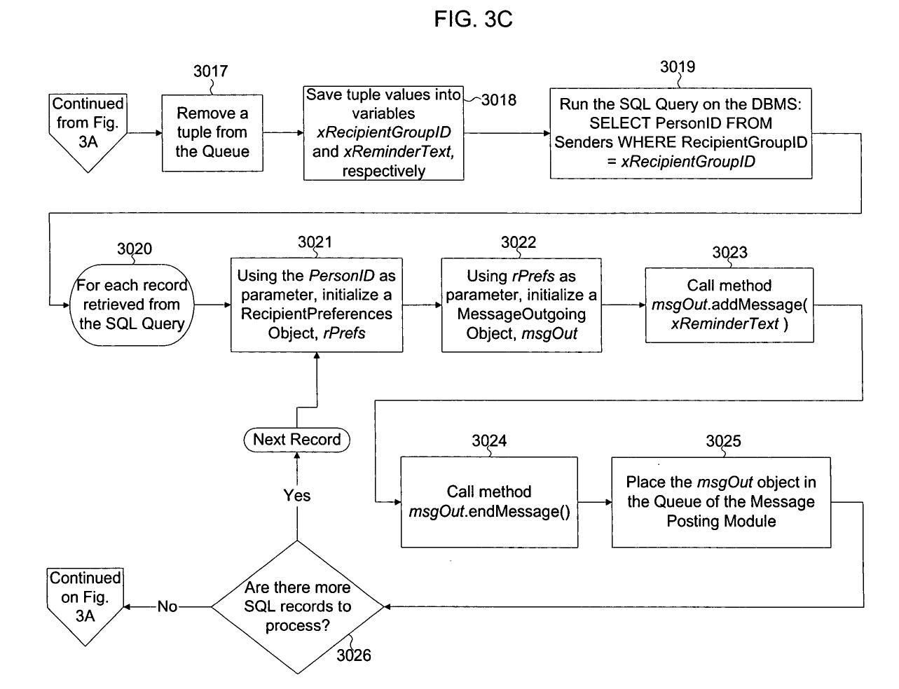

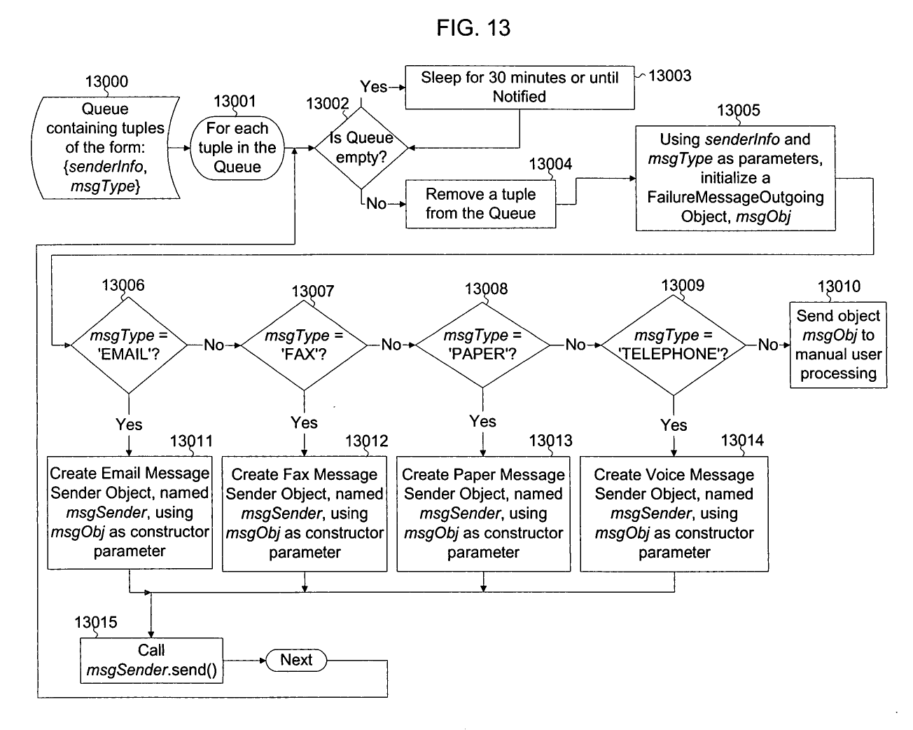

The recipient(s) 1011 then receives the message. Two additional modules, a Reminder Module 3 further elaborated in FIGS. 3A, 3B, and 3C (encompassing 27 steps, 3000 to 3026) and a Failure Posting Module 13 further described in FIG. 13 (encompassing 16 steps, 13000 to 13015), are also part of the invention.

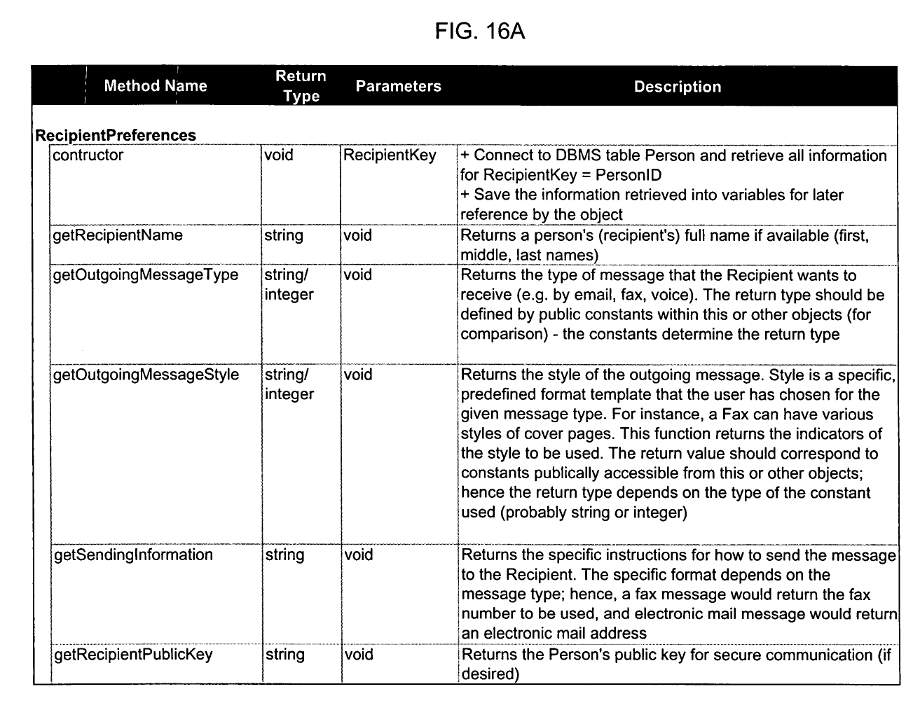

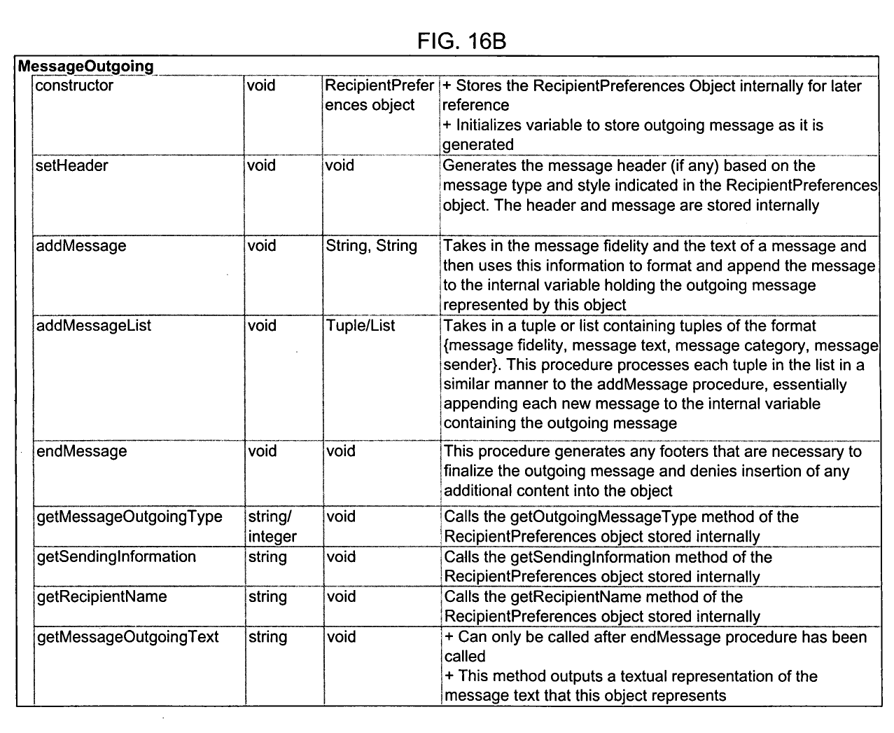

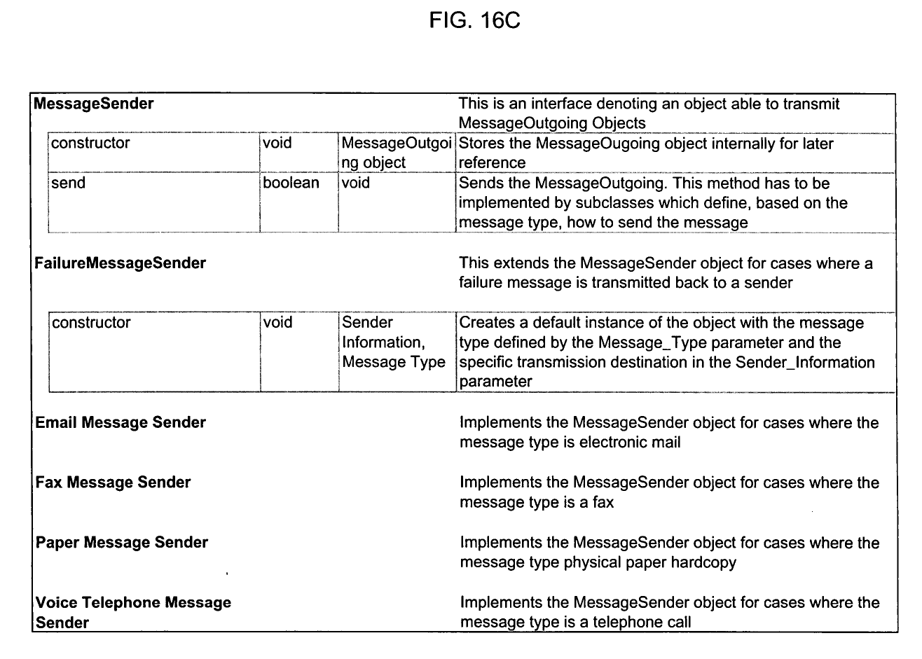

Modules may be implemented as separate operating system processes on separate computer systems connected through a computer network, as separate operating system processes on a single computer, or with minor modification as procedure calls within one operating system process. The invention also utilizes programming objects for some of its tasks. FIG. 16 contains a list of programming objects and a description of their respective interfaces, which details functions used by the invention. The functionality of these objects could be replaced with modules or standard procedure calls, and the invention does not require the specific use of objects so long as alternate implementations posses the same functionality and provide similar end-results.

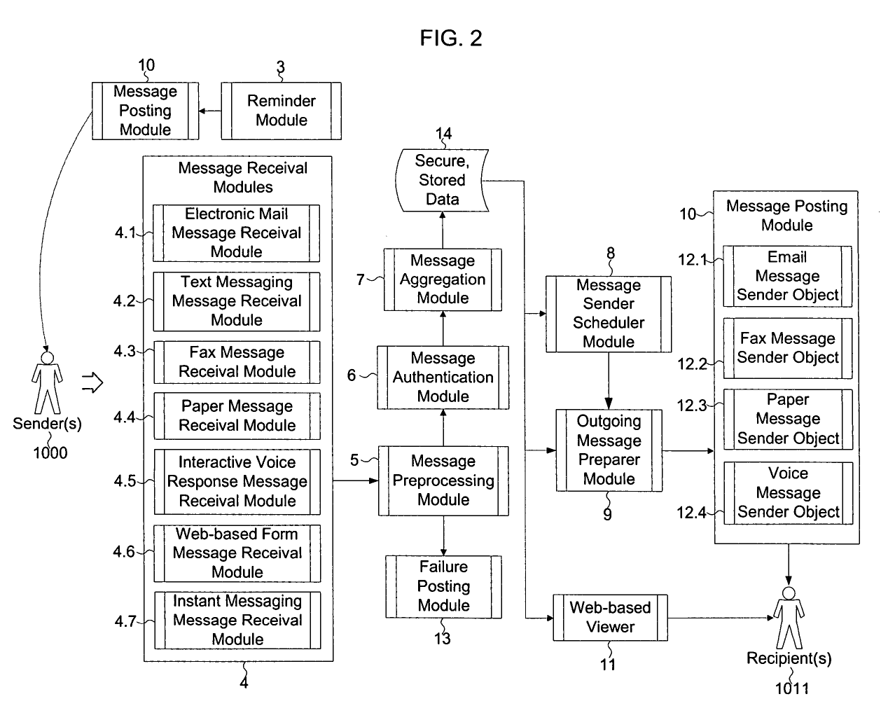

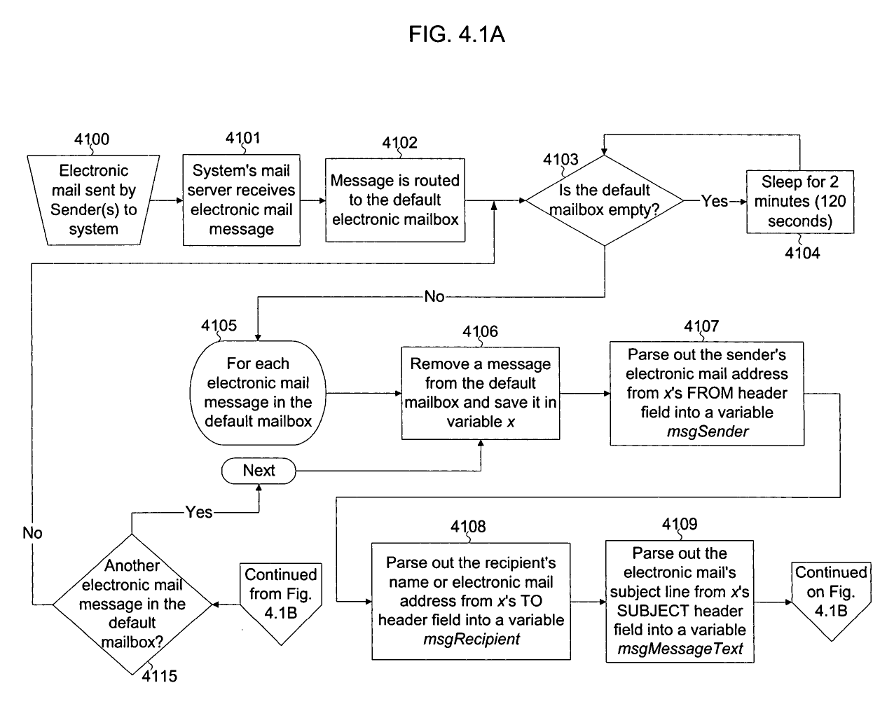

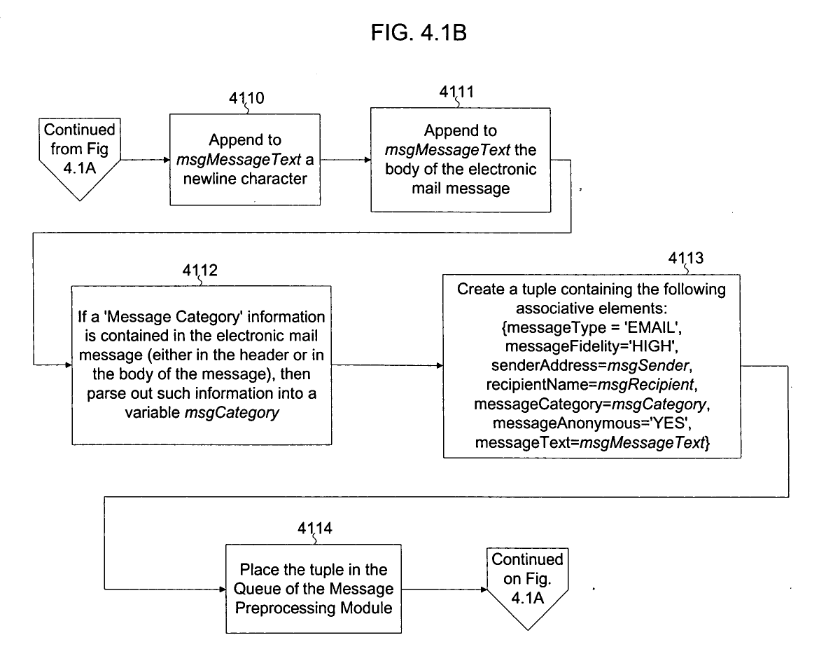

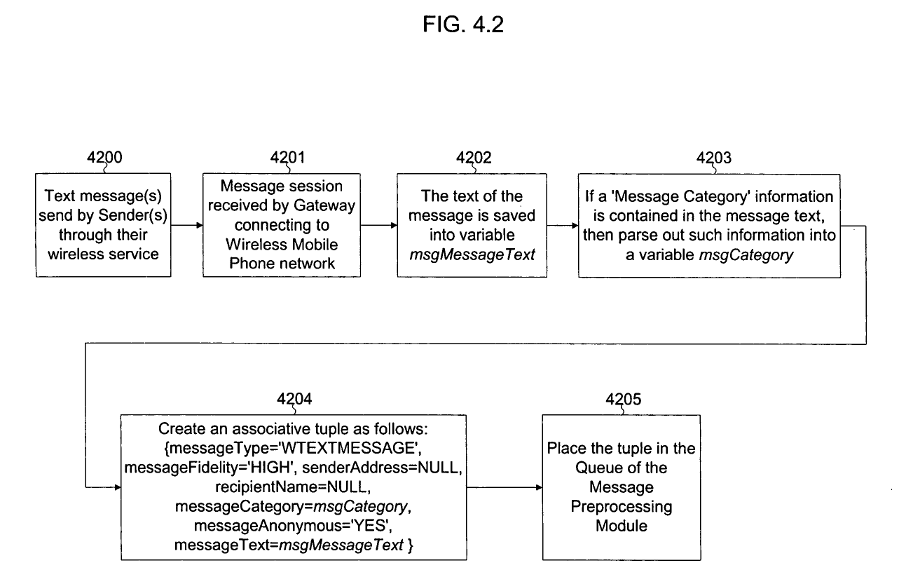

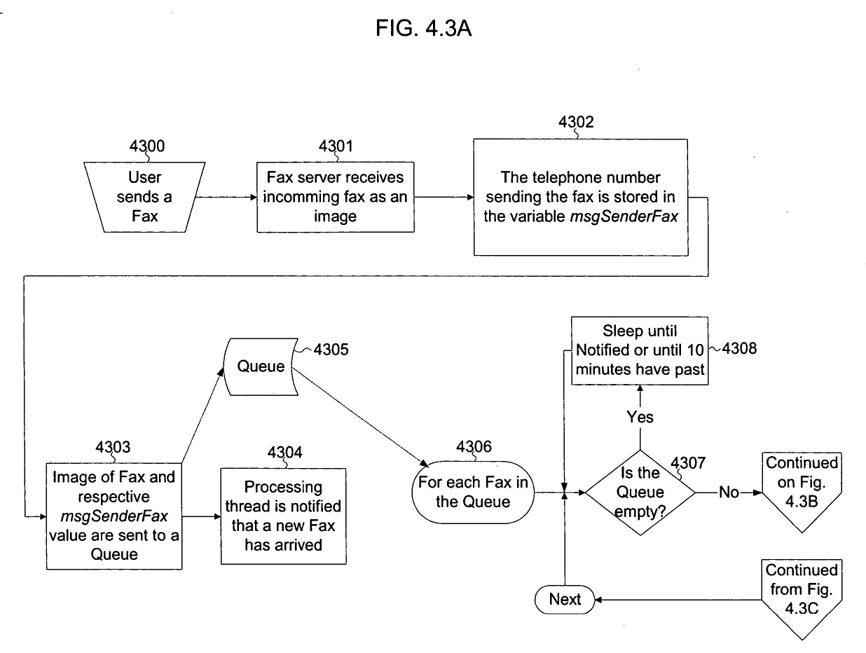

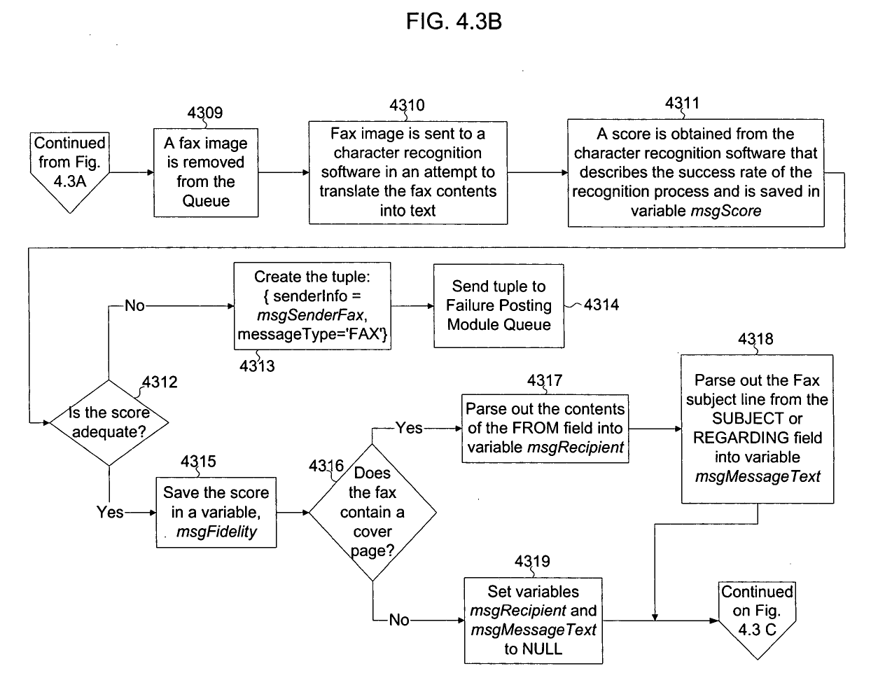

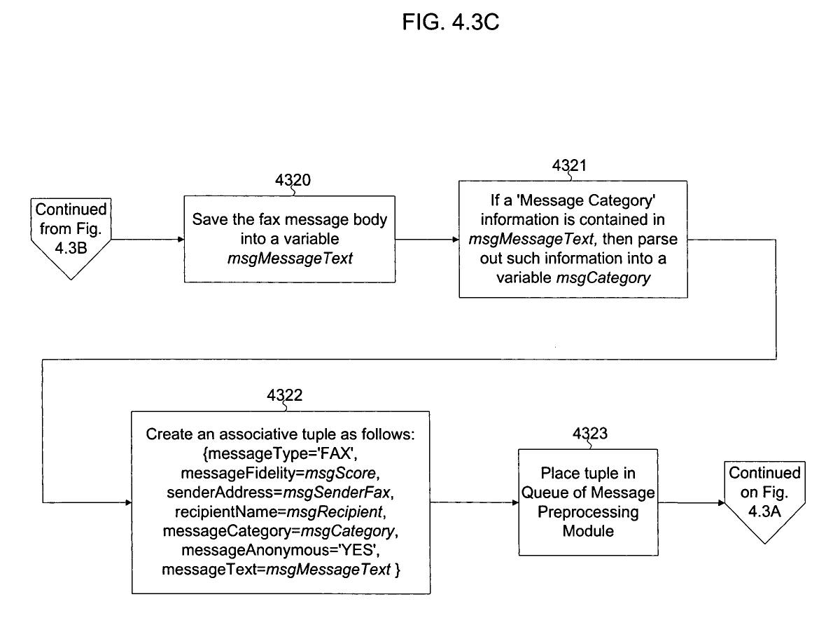

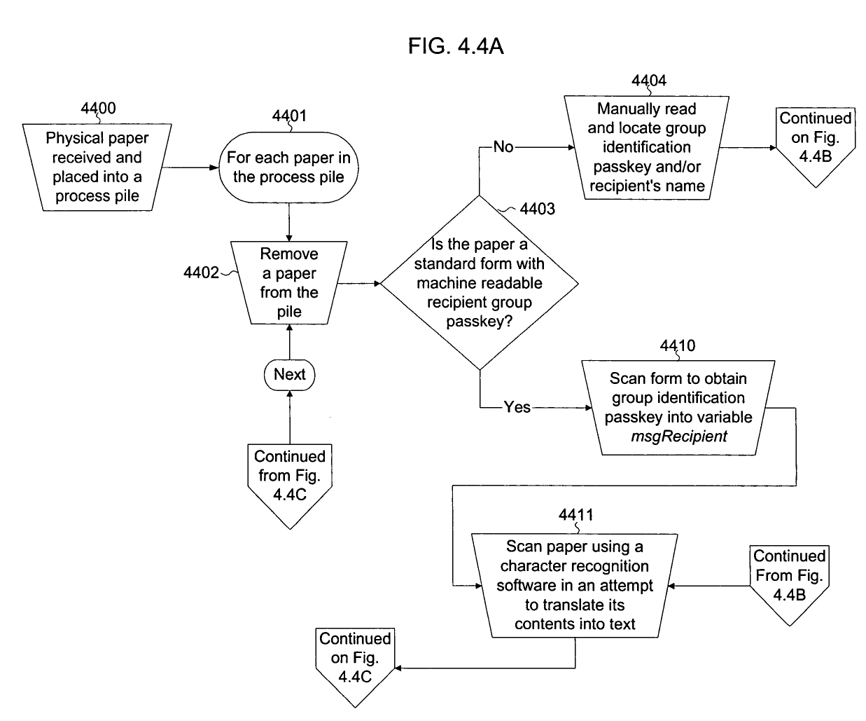

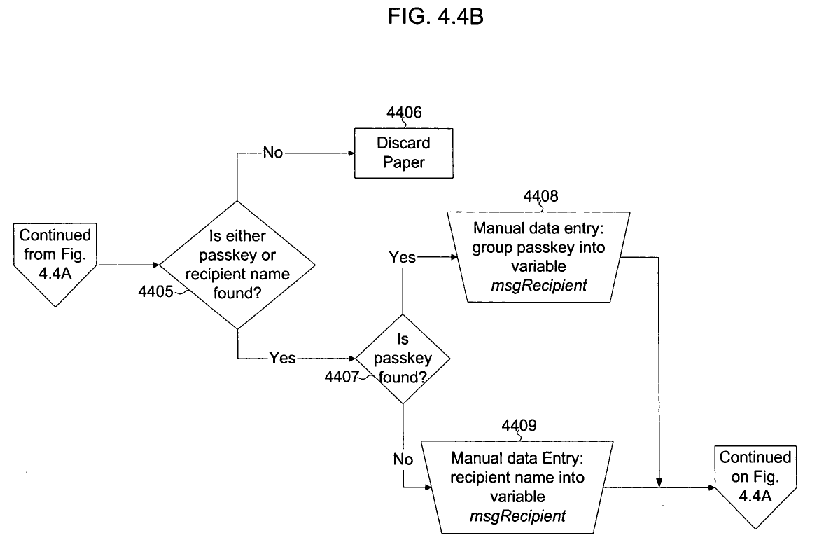

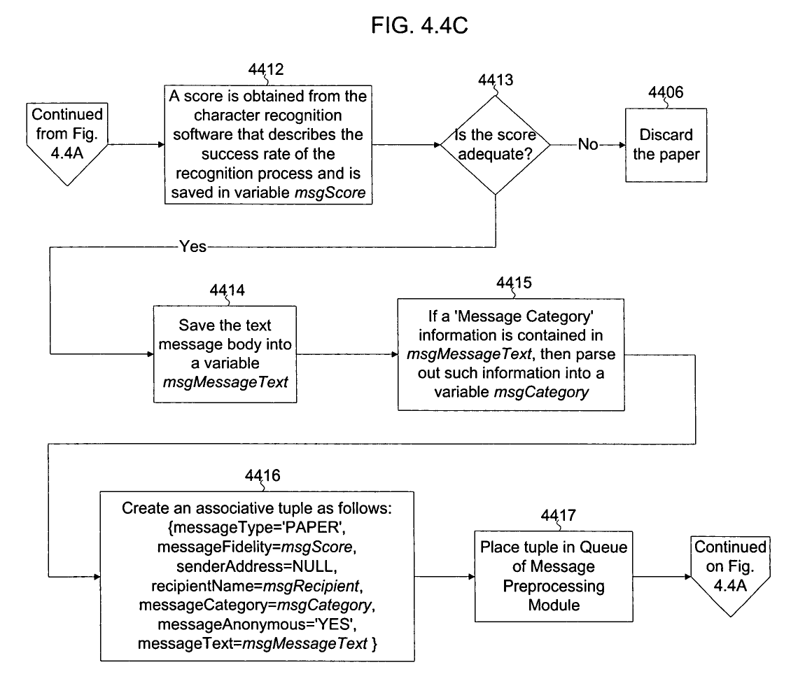

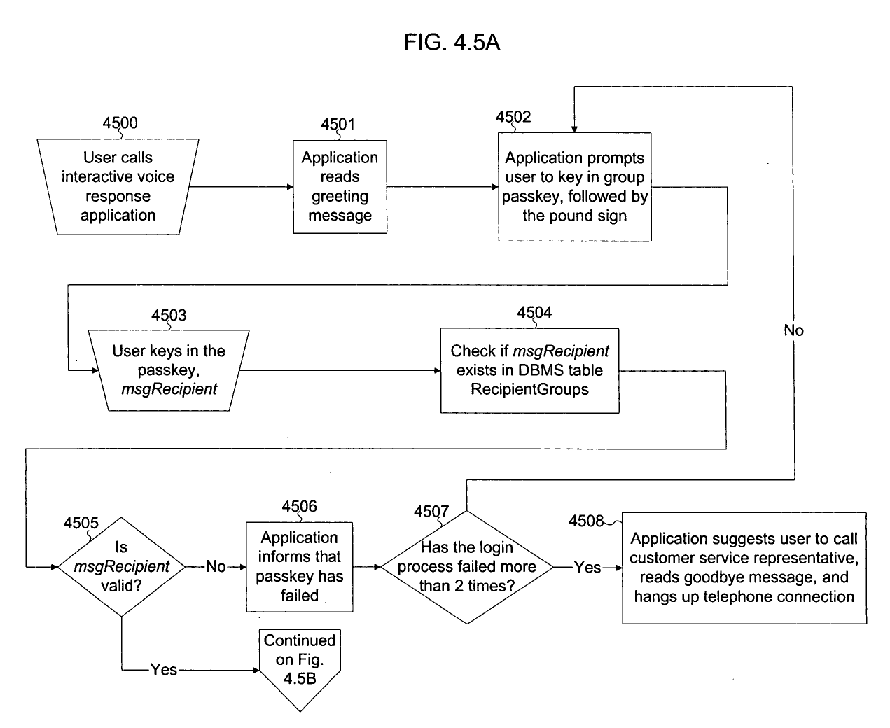

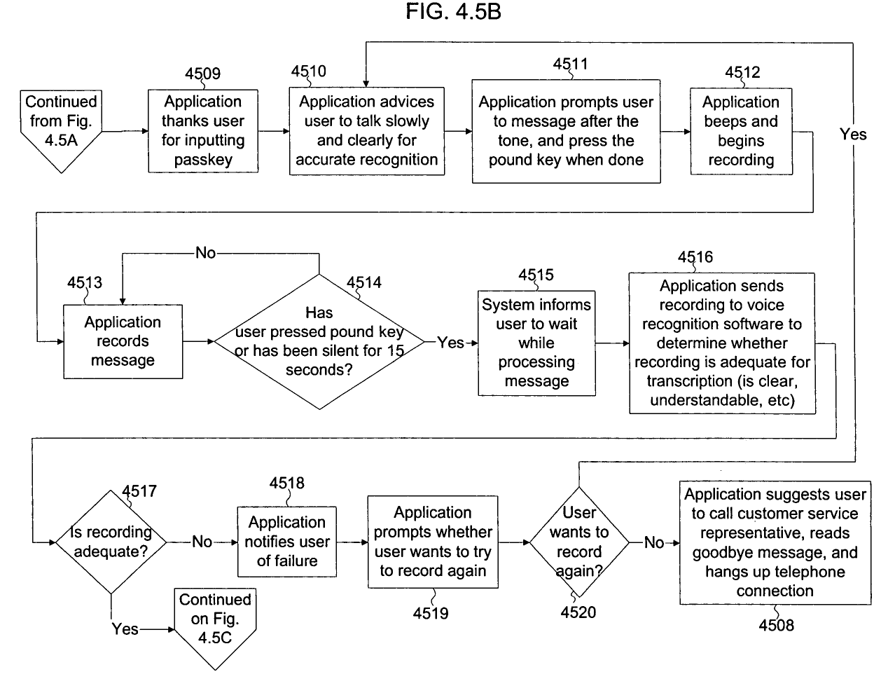

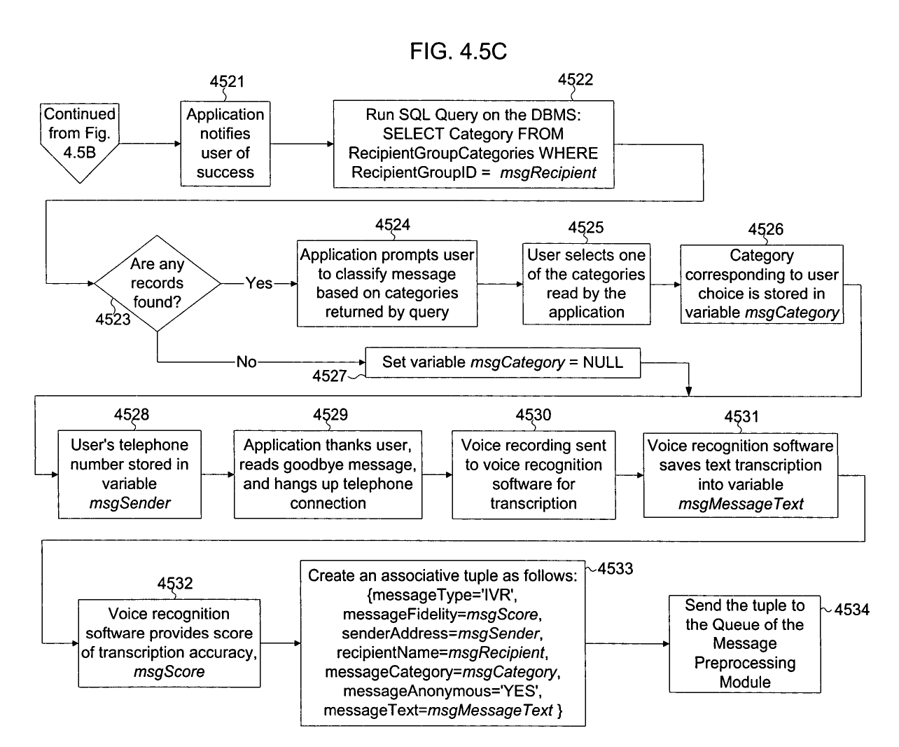

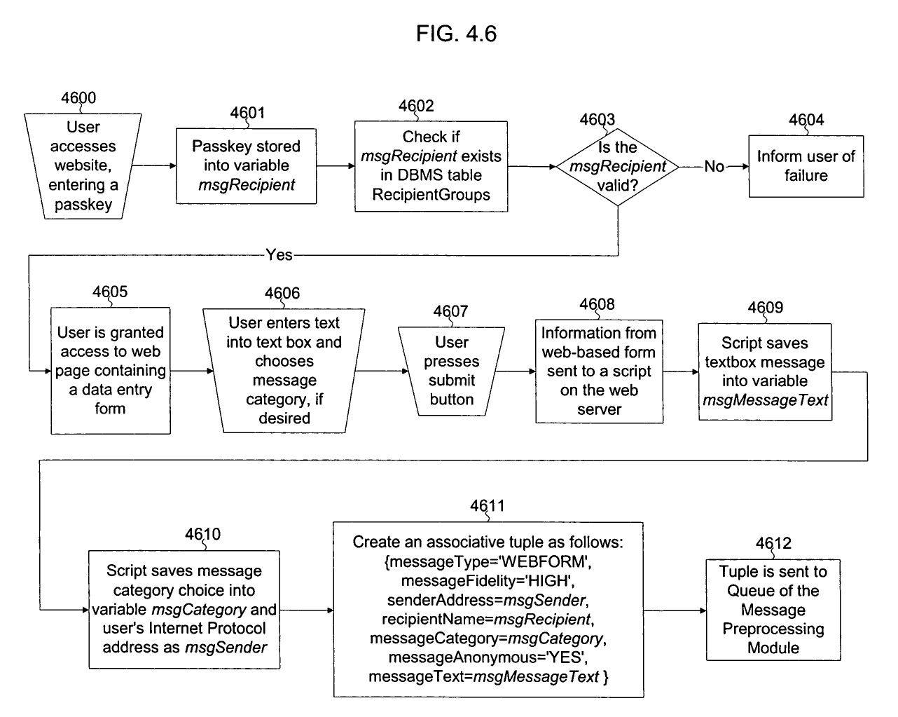

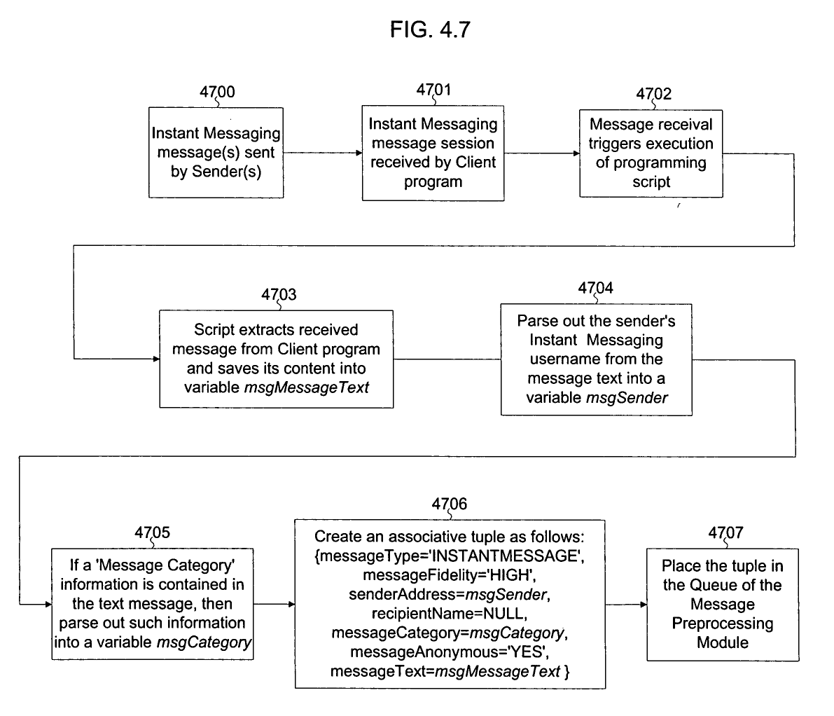

In its preferred embodiment, the invention is augmented, as shown in FIG. 2, with additional modules and programming objects providing more specific means for the system to receive messages from a sender and to transmit messages to a recipient group. Those skilled in the art may appreciate, however, that additional modules or objects for message receival and transmission could be added to those presently discussed, and the invention is not limited only to those herein described. Senders may send messages through seven means, each processed by a separate module:
(a) electronic mail through the Electronic Mail Message Receival Module 4.1 further described in FIGS. 4.1A and 4.1B (encompassing 16 steps, 4100 to 4115);
(b) wireless text messaging through the Text Messaging Message Receival Module 4.2 further described in FIG. 4.2 (encompassing 6 steps, 4200 to 4205);
(c) facsimile through the Fax Message Receival Module 4.3 further described in FIGS. 4.3A, 4.3B, and 4.3C (encompassing 24 steps, 4300 to 4323);
(d) paper hardcopy through the Paper Message Receival Module 4.4 further described in FIGS. 4.4A, 4.4B, and 4.4C (encompassing 18 steps, 4400 to 4417);
(e) an interactive voice response-guided voice message through the Interactive Voice Response Message Receival Module 4.5 further described in FIGS. 4.5A, 4.5B, and 4.5C (encompassing 35 steps, 4500 to 4534);
(f) an Internet-based website through the Web-based Form Message Receival Module 4.6 further described in FIG. 4.6 (encompassing 13 steps, 4600 to 4612); and
(g) instant messaging through the Instant Messaging Message Receival Module 4.7 further described in FIG. 4.7 (encompassing 8 steps 4700 to 4707).

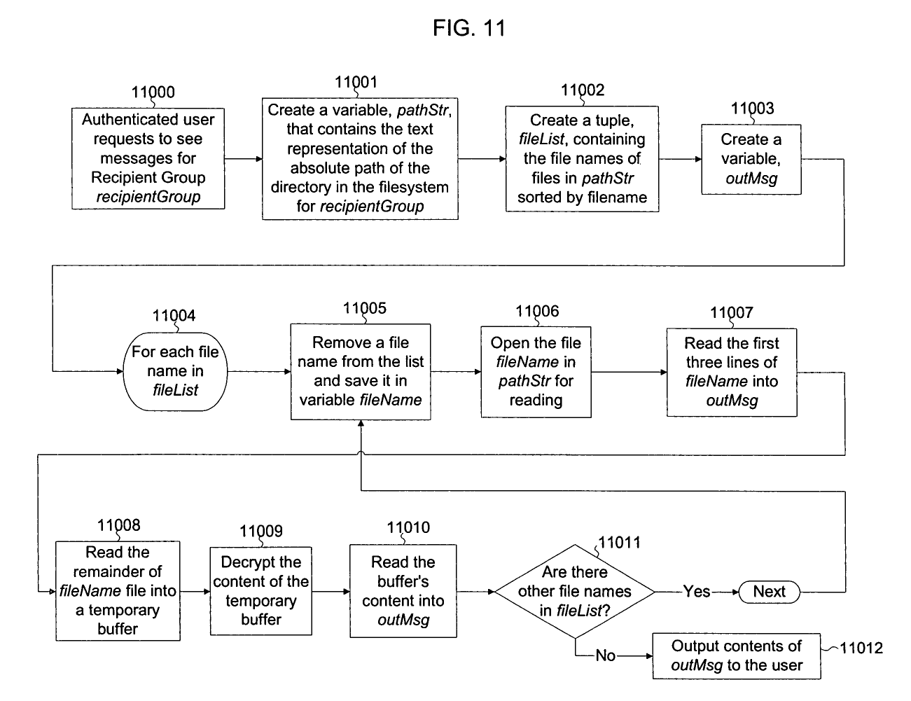

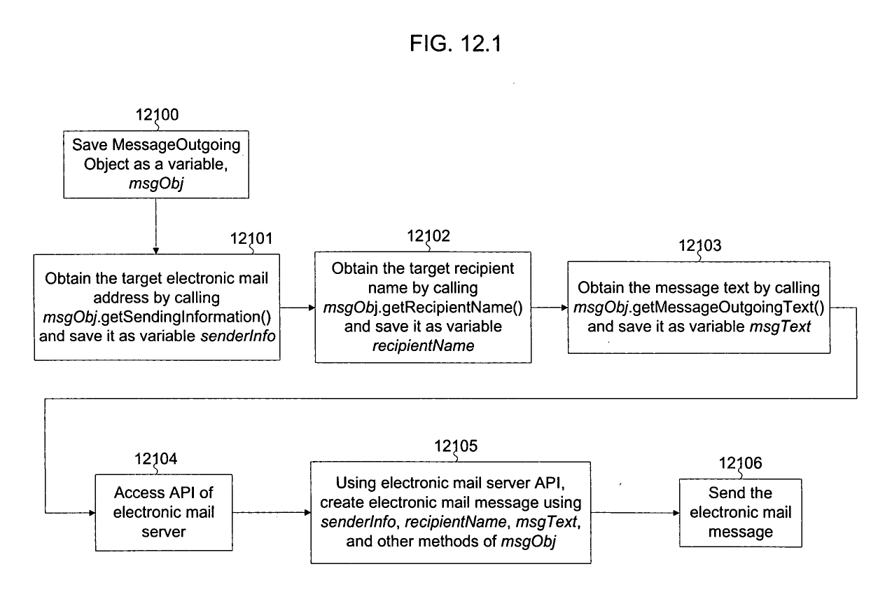

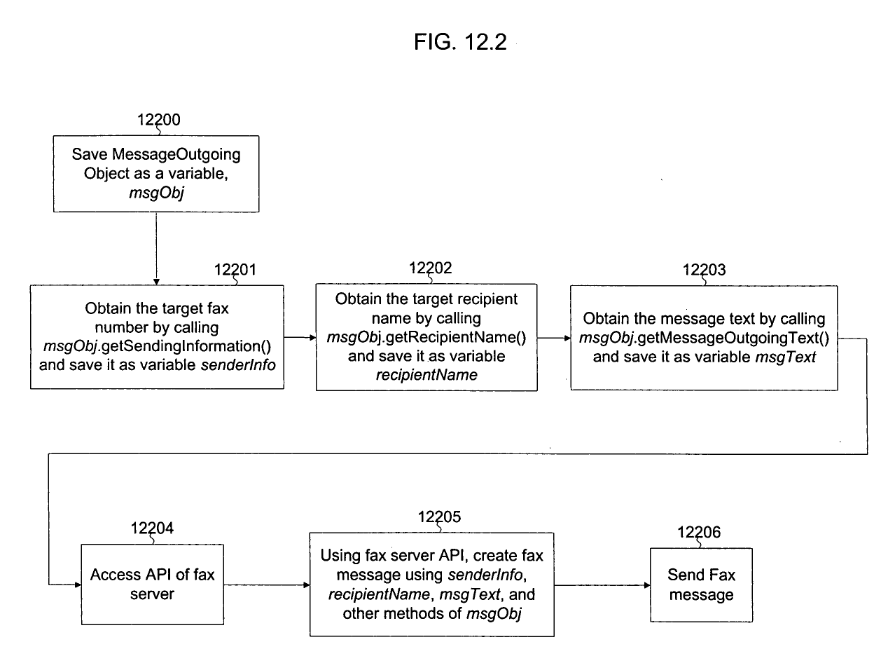

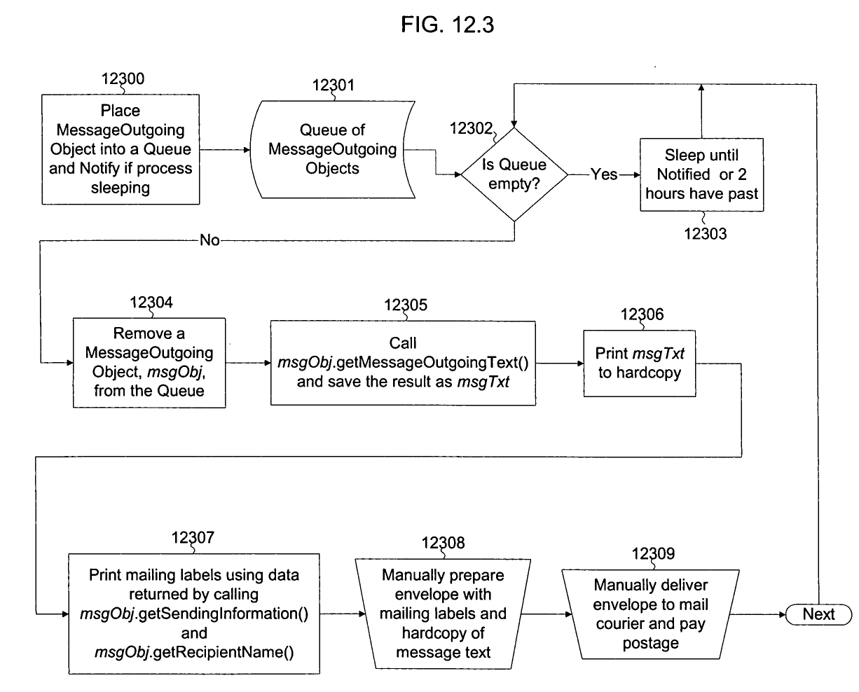

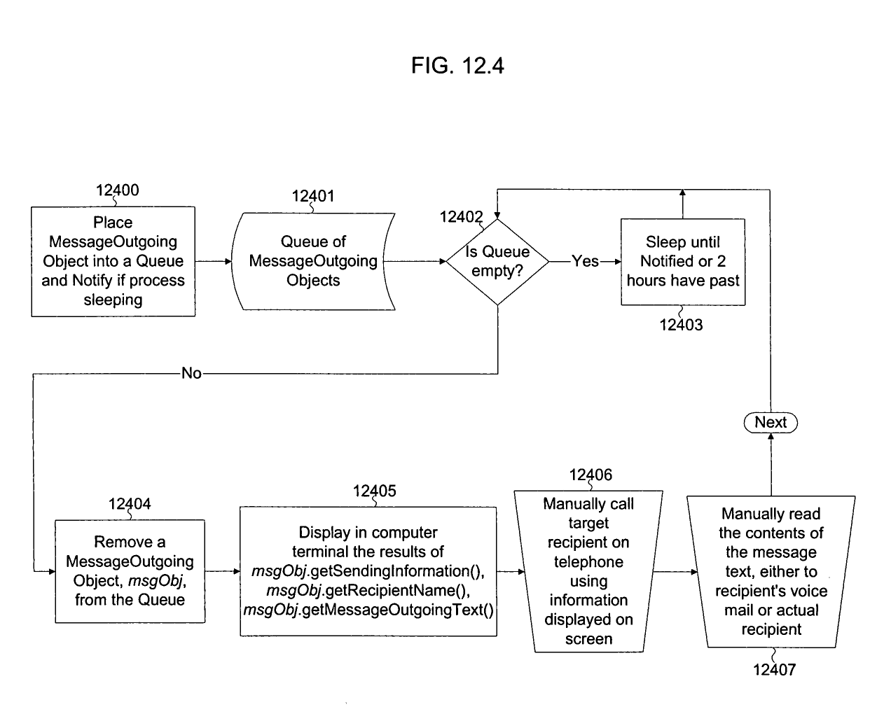

Receivers may receive messages through five means, each processed by a separate object or module:
(a) a web page located on a website through the Web-based Viewer Module 11 further described in FIG. 11 (encompassing 13 steps, 11000 to 11012);
(b) electronic mail through the Email Message Sender Object 12.1 further described in FIG. 12.1 (encompassing 7 steps, 12100 to 12106);
(c) facsimile through the Fax Message Sender Object 12.2 further described in FIG. 12.2 (encompassing 7 steps, 12200 to 12206);
(d) paper hardcopy through the Paper Message Sender Object 12.3 further described in FIG. 12.3 (encompassing 10 steps, 12300 to 12309); and
(e) telephone through the Voice Message Sender Object 12.4 further described in FIG. 12.4 (encompassing 8 steps, 12400 to 12407).

In its preferred embodiment, the invention requires additional tools for operation. First, it would need an electronic mail system that can receive messages 4101, store messages in a mailbox 4102, and send electronic mail 12106. Application programming interfaces (APIs) or other programming language facilities would also be necessary to enable creation of electronic mail messages 12105. Second, a gateway or other means for receiving wireless text messaging messages 4201 is necessary. Third, the invention would require a facsimile system that could receive facsimiles as image files 4301, record and store the sending fax machine's telephone number 4302, and send facsimiles 12206. APIs or other facilities for creation of facsimiles 12205 are also necessary. Fourth, an interactive voice response system is also needed that is able to convey information to users, record information spoken by users, and otherwise process information as outlined in FIGS. 4.5A, 4.5B, and 4.5C. Fifth, client programs for popular instant messaging services are needed that receive instant messaging messages 4701 and allow script programs to access these messages, as described in FIG. 4.7. Sixth, the invention requires a website that authenticates users in order to grant them web page access 4600 and 11000, conveys information to users 4604, 4605, and 11012, and receives information from users 4608. Lastly, character recognition software and voice recognition software are needed that are able to rate the quality of image 4311 and 4412 and voice 4516 data inputs and to transcribe these inputs to electronic text 4310, 4411, and 4530. All of the aforementioned tools or technologies exist and could be either built, acquired freely from open sources, or purchased commercially. Additionally, this invention is not limited solely to the use of these tools for its operation, since the functional requirements of a tool's use in the invention can be achieved through use of substitutes, such as human labor, or tools developed in the future.

The modules and programming objects depicted in FIGS. 3A to 13 utilize several common programming language constructs that can be implemented in various fashions. Specific use of a construct does not limit the invention to the sole use of that construct should another construct also achieve the same aim. For instance, the invention utilizes several electronic queues for its functionality 3000, 4306, 5000, 7000, 9000, 10000, 12301, 12401, 13000. Some of these queues could be replaced with other constructs, such as stacks, database tables, or binary trees, with little impact on the functionality of the invention. Another frequently used construct is a tuple, otherwise known as a bag, collection, array, or set (created in 3010, 4113, 4204, 4313, 4322, 4416, 4533, 4611, 4706, 5013, 5014, 5017, 6010, 6018, 6019, 8010, 9007, 9013, 9016, 9025, 11002; otherwise utilized in throughout the invention). Other constructs used may become evident in the discussion of the operation of the invention below.

Operation of Invention

A preferred embodiment of the invention is illustrated at a high level in FIG. 2. A sender 1000 transmits a feedback message through various means. Electronic mail messages are received by an Electronic Mail Message Receival Module 4.1. Wireless text messages are received by a Text Messaging Message Receival Module 4.2. Fascimiles are received by a Fax Message Receival Module 4.3. Inbound hardcopy paper messages are handled by a Paper Message Receival Module 4.4. Voice messages are received through an Interactive Voice Response Message Receival Module 4.5. Submissions from a website are received by a Web-based Form Message Receival Module 4.6. Instant Messaging messages are received by an Instant Messaging Message Receival Module 4.7. All of these modules (4.1 to 4.7) convert messages to electronic text and relay the text to a Message Preprocessing Module 5. This module parses the message, assigns variables with values based on the content of the message, and sends this information to a Message Authentication Module 6. The latter then verifies that the sender has supplied a valid passkey and is authorized to send the recipient group the message. A Message Aggregation Module 7 subsequently stores the message in the file system of a computer system. A Message Sender Scheduler Module 8 periodically initiates execution and checks whether certain criteria have been met. These criteria aim to obfuscate traffic monitoring efforts by recipients by delaying transmission of messages a random amount of time and by transmitting one communication containing all received messages organized in a random order. The module retrieves information defining the messages that should be sent to a recipient group and forwards this list to an Outgoing Message Preparer Module 9. The latter module formats the message for transmission, ensuring the exclusion of sender-identifying information. A Message Posting Module 10 utilizes several programming objects for transmitting messages in a format specified by each recipient member of the recipient group. Electronic mails are sent by an Email Message Sender Object 12.1. Fascimiles are sent by a Fax Message Sender Object 12.2. Physical hardcopy is sent by a Paper Message Sender Object 12.3. Voice messages are transmitted by a Voice Message Sender Object 12.4. Messages are also accessible through a World Wide Web website using a Web-based Viewer Module 11. A Reminder Module 3 sends messages to senders to encourage, remind, and urge them to send feedback. A Failure Posting Module 13 sends messages to senders in cases where sender messages failed to be authenticated or were otherwise invalidated by the system.

FIGS. 3A, 3B, and 3C—Reminder Module

The Reminder Module is an optional component of the invention that can be utilized by some recipient groups and not others to periodically remind senders to provide feedback messages. Using this module requires that recipient groups define the senders to be reminded and the frequency with which these reminders messages should be sent.

The Module checks whether a queue 3000 is empty 3001. If it is, information is obtained from a database 3002 and is stored in a variable 3003 that indicates the next time the Reminder Module should check the queue. The amount of time in seconds for which the Module's execution should sleep is then calculated 3004. After sleeping 3005, information is obtained indicating what recipient groups' senders should be reminded 3007. Information about each of these recipient groups, 3008 and 3009, is then saved in tuples 3010 and placed 3011 in the queue 3000. If a recipient group's reminder information is defined by an update rule (e.g. “every Sunday at 9:00 pm”) 3012, then the database is modified to indicate the next time that the group should be reminded 3015; otherwise, expired database records are removed 3013. The queue is subsequently checked 3001 again. Should the queue be non-empty, a tuple is removed from the queue 3017, and its contents are saved in variables 3018. The senders related to the recipient group are obtained from the database 3019. Information retrieved about each sender is used to initialize a RecipientPreferences Object 3021 and subsequently a MessageOutgoing Object 3022. A recipient group-defined message reminding the senders to send feedback is placed into the MessageOutgoing Object 3023. The MessageOutgoing Object is then closed 3024 and sent to the queue 10000 of the Message Posting Module, described in FIG. 10.

In an alternative embodiment of the Reminder Module, the recipient group-defined message could be periodically modified by recipient groups. These messages could contain specific questions regarding topics about which recipients want to receive feedback. Alternatively, the recipient group-defined message could simply be a survey-style questionnaire which captures information such as performance review-related comments. Another embodiment for the Reminder Module would involve posting the recipient group-defined message on a web site, which senders could access using the same identifying code used to send recipient messages.

FIGS. 4.1A to 4.7—Receival Modules

FIGS. 4.1A to 4.7 describe modules enabling the system to receive messages through various media and transmission modes. All modules perform five basic functions:
(a) They receive a message from a sender;
(b) They digitize, convert, or reformat the message into electronic text;
(c) They parse the message to obtain specific information. Where possible, this information includes sender or sending information, a passkey or the intended recipient group, a category classifying the message, and the subject and body of the message;
(d) They derive additional information fields, including the type of transmission method used, the accuracy or fidelity of the message's textual representation vis-à-vis its original format, and an indication that the message is to be treated anonymously; and
(e) They send the information obtained in (c) and (d) as a tuple to the Message Preprocessing Module queue 5000.

The implementation of each module is dependent upon the nature of the transmission mode involved, and although FIGS. 4.1A to 4.7 outline an implementation of each module, other implementations could be used that perform the five basic functions outlined above. Consequently, the invention's receival modules can encompass other implementations that simulate or perform the same steps outlined above.

FIGS. 4.1A, 4.1B, 4.2, and 4.7 involve receival of electronic mail messages, wireless text messaging messages, and instant messaging messages. As the format in which these messages are received is electronic text, these modules comprise the more straightforward cases. A message is received 4101, 4201, and 4701. Note that owing to message size limitations inherent in wireless text messaging and instant messaging applications, the message that the invention receives may be composed of several short messages sent sequentially by the sender. The term message session is used in steps 4201 and 4701 to denote this possibility. Subsequently, the message is parsed to obtain specific information 4107, 4108, 4109, 4112, 4203, 4704, and 4705. This information is placed in a tuple 4113, 4204, and 4706, along with module-derived values. The information is then sent 4114, 4205, and 4707 to the Message Processing Module queue 5000. Alternative implementations of a gateway that receives wireless text messaging messages 4201 or of a script that extracts instant messaging messages 4703 could involve the use of manual labor to receive, extract, and insert messages received into the invention.

Messages received from website form submission, described in FIG. 4.6, are also electronic text. The subtle difference in this case involves the need for senders to gain access to a website form using a passkey 4600, to have the passkey authenticated 4602 and 4603, and to enter data into the form 4606. As a result of using a structured form, message parsing is not necessary; rather, separate form elements each contain message-related information fields 4601, 4609, and 4610.

Alternative embodiments for receival methods involving electronic communication, such as those above, could include the use of encryption to secure the communications channel from the sender to the invention. This could be performed through the use of digital certificates, Secure Sockets Layer-based communications, or through other methods that enable secure message transmission.

FIGS. 4.3A, 4.3B, 4.3C, 4.4A, 4.4B, and 4.4C involve receival of information as facsimile or paper hardcopy. These messages are received in formats that need conversion to electronic text. In both instances, character recognition software is used for the conversion 4310 and 4411. Paper processing also involves manual labor in the receival 4400; handling 4402; scanning 4404, 4410, 4411; and content parsing 4408 and 4409 of a paper document. Fax server software automatically receives messages in digital image format, consequently not requiring manual intervention. Following conversion to electronic text, the message contents are parsed 4317, 4318, 4321, and 4415. Additional information about the message is also generated 4302, 4311, 4315, and 4412. A tuple containing this information is then created 4322 and 4416 and sent 4323 and 4417 to the Message Processing Module queue 5000.

FIGS. 4.5A, 4.5B, and 4.5C involve receival of voice messages. Similar to the above, such messages require conversion to electronic text, and this is achieved using voice recognition software 4516 and 4530. Use of an interactive voice response system helps to structure user interaction with the system, facilitating data collection of the passkey 4502 and 4503, the message 4511 and 4513, and the message classification 4524 and 4526. These pieces of information coupled with those generated about the sender 4528 and the message 4532 are placed into a tuple 4533 and sent 4534 to the Message Processing Module queue 5000.

FIGS. 5A and 5B—Message Preprocessing Module

The Message Preprocessing Module queue 5000 is checked for tuples 5001. If the queue is empty, the execution of the program sleeps for an arbitrary amount of time 5002. When the queue has tuples, each tuple is checked whether it contains a group identification passkey 5004. This passkey can be unique to each sender or can be a common passkey for all senders of a recipient group. The message text may also be searched if the passkey is not readily found 5005, 5008, and 5009. The message text is then encrypted in a manner such that its contents are not easily readable by potential perpetrators 5016. Note that this encryption step could be performed by the Message Authentication Module with no material impact on the functionality or usefulness of the invention method. Also note that several encryption methodologies exist which could be employed for the message encryption step, and the invention does not depend on the use of a specific encryption algorithm. The message information is then repackaged into another tuple 5017 and sent 5018 to the Message Authorization Module 6.

FIGS. 6A, 6B, and 6C—Message Authorization Module

The Message Authorization Module receives a tuple containing message information 6000. Validation of the message tuple is then performed in various ways. If a group identification passkey was isolated by the Message Preprocessing Module and is contained in the tuple 6001 and 6002, then the database is searched to verify the validity of the passkey 6005 and 6013. Validation of a sender is consequently established on the basis of a message containing this passkey. Alternatively, validation could also be undertaken through a multi-factored approach that inspects the passkey in conjunction with other information such as sender information. A recipient group identification number, which uniquely identifies recipient groups within the system, is then obtained 6016. If a passkey is not found in the tuple but both a recipient's name and sender information are included, these data can be used for identifying a recipient group identification number 6004 and 6006. In this situation, the fact that the message was validated in this fashion is recorded 6011. Messages that are unable to resolve to a recipient group are sent 6010 to a Failure Message Posting Module queue 13000. Authenticated messages are sent 6020 to the Message Aggregation Module queue 7000.

FIGS. 7A and 7B—Message Aggregation Module

A tuple containing message information is removed 7002 from the Message Aggregation Module queue 7000. A random number is generated 7007 and is used as the name of a newly created file 7009 in the computer file system directory 7003 associated with the recipient group identification number stored in the tuple. Information regarding the message is stored in the file 7010 to 7017. In another possible embodiment, messages could be stored within a database instead of a file, without significant impact on the functionality of the invention. Additional database tables would be needed to provide such functionality. Additional information regarding the message classification is then stored into the database 7020. The system then increments the number of messages awaiting delivery to the recipient group 7025.

FIG. 8—Message Sender Scheduler Module

The Message Sender Scheduler Module sleeps for a random amount of time, between 2 and 12 hours 8001. These time boundaries (2 and 12 hours) are imposed to assure that the system does not stay idle for an exorbitant amount of time, and the specific values for these boundaries can vary based upon the performance level desired from the invention. Once awake, the Module queries the database for recipient groups who have received messages that meet certain criteria 8005. These criteria aim at obfuscating traffic monitoring efforts by recipients. Several criteria can be employed, and the criteria disclosed do not limit the applicability of other or additional criteria. The criteria disclosed require that a recipient group has received at least four messages or, if fewer, that the messages are at least 4 days old. The former makes it difficult for recipients to match observed sender behavior with a particular message, since outbound messages will not necessarily list stored messages in the order received by the invention. The latter ensures that messages do not stay idle in the system but delays transmission sufficiently long that recipients may have purged monitoring data. The module sends 8011 tuples 8010 identifying recipient groups who are to receive messages to the Outgoing Message Preparer Module queue 9000. The recipient groups' criteria information is updated 8013 to reflect the fact that they are being sent a message.

FIGS. 9A, 9B, and 9C—Outgoing Message Preparer Module

A tuple is removed 9005 from the Outgoing Message Preparer Module queue 9000. A file system directory associated with the recipient group contained in the tuple is located 9006. A list of file names from this directory is then obtained using additional information contained in the tuple 9008 to 9015. This list is sorted by file name 9008. Since file names were generated randomly, sorting by name should provide a random ordering relative to when the messages were received by the invention. The contents of each file are read into a tuple 9016 to 9026. Then, for each recipient within the target recipient group, a RecipientPreferences Object 9030 and a MessageOutgoing Object 9031 are generated. The tuple containing the files' contents are then used to furnish the MessageOutgoing Object with content 9032. This MessageOutgoing Object is sent 9035 to the Message Posting Module queue 10000. The system records the fact that a specific recipient has been sent a message 9034. If outlined by recipient group preferences 9037, all files in its file system directory are then deleted 9039.

FIG. 10—Message Posting Module

MessageOutgoing Objects are successively removed 10004 from the Message Posting Module queue 10000. For each, a function call is performed that retrieves the preferred transmission mode for the outgoing message 10005. This information and the MessageOutgoing Object are then used to construct a MessageSender-typed object specific to the transmission mode required 10006 to 10014. For instance, preference for electronic mail delivery leads to the creation of an Email Message Sender Object 10011. These objects are in turn used to send the message to a recipient through a function call 10015 common to all objects of the type MessageSender. Further details about this function call are illustrated in FIGS. 12.1 to 12.4 for each MessageSender-typed object.

FIG. 11—Web-based Viewer Module

An authenticated user requests to view messages for a given recipient group through a web page 11000. A file system directory associated with the recipient group is identified 11001. A list of files in the directory is obtained, sorted by name, and stored in a tuple 11002. The content of each file is appended into a variable, portions requiring possible decryption 11007 to 11010. This variable is then output for display to the user 11012. Additional steps involving formatting of message content can be included in alternative embodiments and implementations. Additionally, the web page could enable users to sort messages based on message classification or other collected information, if such information is provided. Encryption through Secure Sockets Layer or similar protocols could enable secure delivery of information to recipients.

FIGS. 12.1 to 12.4—MessageSender Objects' Send Methods

FIGS. 12.1 to 12.4 describe four different objects, each of which implements the MessageSender interface, further described in FIG. 16. The main purpose of these objects is to transmit outgoing messages, contained in MessageOutgoing Objects, to recipients. Accordingly, FIGS. 12.1 to 12.4 describe this sending process.

FIGS. 12.1 and 12.2 involve transmission of messages through electronic mail and facsimile. In both cases, a MessageOutgoing Object is accessed 12100 and 12200 and used to obtain the message content and message destination information 12101, 12102, 12103, 12201, 12202, and 12203. APIs from electronic mail or facsimile software are accessed 12104 and 12204 and then used to prepare an outbound message 12105 and 12205. The message is then sent 12106 and 12206. Alternative embodiments for the case of electronic mail could include the encryption of outgoing messages using digital keys or other cryptographic algorithms that would enable recipients to receive messages securely from the invention.

FIGS. 12.3 and 12.4 involve transmission of messages as paper hardcopy or as a telephone voice message, respectively. Both of these methods involve some manual labor processes. FIGS. 12.3 and 12.4 accordingly intermingles the tasks performed by MessageSender-typed objects with those performed by manual human labor. Again, some manual tasks could be automated based on future technological advances, and this invention could encompass implementations involving more automated processes. Referring to FIG. 12.3, a MessageOutgoing Object is placed 12300 in a queue 12301 for processing. For each MessageOutgoing Object in the queue, information about the message is extracted 12305 and 12307 and used to print the message 12306 and mailing labels 12307. Manual labor is then used to prepare a mailing envelope 12308 and to send it via mail courier 12309. Referring to FIG. 12.4, a MessageOutgoing Object is placed 12400 into a queue 12401. For each object, message content and destination information is extracted and displayed on a computer terminal 12405. A human operator then uses this information to telephone a recipient 12406 and read the contents of the message text 12407. Alternative embodiments could include the use of telephone auto-dialing software and speech-generating software, instead of a human operator, to telephone the recipient and read the contents of the message text.

FIG. 13—Failure Posting Module

For each tuple in the Failure Posting Module queue 13000, a sender's destination information and message transmission mode are used to instantiate a FailureMessageOutgoing Object 13005. Based on the transmission mode 13006 to 13009, a MessageSender-type object is instantiated and subsequently used to send the message 13015.

### CONCLUSION, RAMIFICATIONS, AND SCOPE OF INVENTION

Accordingly, the reader will see that the invention overcomes important shortcomings of existing feedback-related inventions. Specifically, senders and recipients have a choice of modes through which to transmit and receive messages, enabling common persons to use the invention to capture feedback insights closer to the point of conception despite lack of access to and sophistication regarding advanced technologies. Senders are provided greater anonymity protection through message aggregation and delay of message transmission. Connections between groups of senders and groups of recipients are also safeguarded through message validation checking. The invention also enables various degrees of connectivity, such as one sender to one recipient, many senders to one recipient, and many senders to many recipients. In situations where all recipients are also senders, the invention could be utilized as an anonymous channel for group messaging, enabling group members to share ideas anonymously with all within the group. This degree of flexibility could empower various types of applications, including simple person-to-person feedback, person-to-organization feedback, group brainstorming, group messaging, and knowledge-capture applications. Other uses also exist which could benefit from the functionality provided by the invention.

Numerous modifications and alternative embodiments of the invention will be apparent to those skilled in the art in view of the foregoing description. For example, implementation of the invention could entirely forgo the use of a database and instead utilize flat files for data storage and retrieval. The message receival and transmission options presented could also be expanded. For instance, the invention could receive telegram messages as well as messages transmitted from hand-held devices that are able to electronically communicate messages. Portable Digital Assistants using Wireless Application Protocol are an example of the latter. The sequence of many processes outlined could also be combined or changed without impact of the final results of the system. For instance the Message Preprocessor Module and Message Authentication Module could be combined into one module, as could the Outgoing Message Preparer Module and portions of the Message Posting Module.

Accordingly, this description is to be construed as illustrative only and is for the purpose of teaching those skilled in the art the best mode of carrying out the invention. Details of the structure may be varied substantially without departing from the spirit of the invention, and the exclusive use of all modifications which come within the scope of the appended claim is reserved.

1. A method for enabling a message to be sent from one or more anonymous senders to one or more known recipients, comprising the steps of:
receiving a message from a sender through a message transmission means which is able to provide the message in a standard format for further processing;
processing said message to obtain an identifying code which uniquely identifies a recipient group, which is composed of one or more recipients;
evaluating said identifying code to ensure that said message is valid for transmission to said recipient group;
storing said message and other information regarding the message in a data storage means that ensures later retrieval of said message and said other information such that the content of said message or said other information is unadulterated and is secure;
evaluating periodically criteria that determine whether said message should be transmitted to said recipient group;
preparing an outgoing message for transmission to said recipient group once said criteria have been fulfilled;
providing said outgoing message with content which includes the content of all messages destined for said recipient group that have not as yet been transmitted to said recipient group and that are stored in said storage means;
removing information regarding the sender from each message included in said outgoing message; and
transmitting said outgoing message to said recipient group, such that each member of said recipient group receives the message;
whereby members of said recipient group can not easily identify the sender of a message and therein enable sender(s) to communicate anonymously with said recipient group.

2. The method as recited in claim 1 wherein said message transmission means is an electronic mail message.

3. The method as recited in claim 1 wherein said message transmission means is a wireless text messaging message.

4. The method as recited in claim 1 wherein said message transmission means is a physical hardcopy paper message.

5. The method as recited in claim 1 wherein said message transmission means is a facsimile.

6. The method as recited in claim 1 wherein said message transmission means is a voice message captured through an interactive voice response system.

7. The method as recited in claim 1 wherein said message transmission means is an instant messaging message.

8. The method as recited in claim 1 wherein said message transmission means is a form within a website that is accessible through an electronic network.

9. The method as recited in claim 1 wherein said identifying code is composed of one value, such as a passkey, sender identifying information, recipient identifying information, or other message-related value.

10. The method as recited in claim 1 wherein said identifying code is a combination of values, such as a passkey and sender identifying information.

11. The method as recited in claim 1 wherein the evaluation of said identifying code is performed by comparing said identifying code with values stored in said data storage means.

12. The method as recited in claim 1 wherein said data storage means comprises of a computer memory accessible through a computer operating system's file system.

13. The method as recited in claim 1 wherein said data storage means comprises of a database management system.

14. The method as recited in claim 1 wherein said criteria comprises of the number of non-transmitted messages destined to said recipient group and the date since last transmission of any message to said recipient group where such criteria is used as a means to overcome attempts by members of said recipient group to guess or estimate the identity of said sender.

15. The method as recited in claim 1 wherein the transmission of said outgoing message is performed through electronic mail.

16. The method as recited in claim 1 wherein the transmission of said outgoing message is performed through facsimile.

17. The method as recited in claim 1 wherein the transmission of said outgoing message is performed through delivery via courier service of a physical paper hardcopy.

18. The method as recited in claim 1 wherein the transmission of said outgoing message is performed through a telephone call.

19. The method as recited in claim 1 wherein the said message content contains a message classification information which can be used as a means for classification of said message into categories.

20. The method as recited in claim 1 further comprising of a website accessible through an electronic network, through which members of said recipient group can view all messages that have been transmitted to said recipient group.

21. The method as recited in claim 1 further comprising of an automated, computer-based system which periodically transmits a reminder message that reminds, urges, or alerts said sender to send a new message to said recipient group, based on a reminder criteria defined by said recipient group that specifies when said reminder message should be sent.
